(19) United States
(12) Patent Application Publication
(10) Pub. No.: US 2025/0124298 A1
(43) Pub. Date: Apr. 17, 2025

(54) Method and System for Adversarial Training and for Analyzing Impact of Fine-Tuning on Deep Learning Models

(71) Applicant: Visa International Service Association, San Francisco, CA (US)

(72) Inventors: Javid Ebrahimi, Redwood City, CA (US); Wei Zhang, Fremont, CA (US); Hao Yang, San Jose, CA (US)

(21) Appl. No.: 18/292,244

(22) PCT Filed: Jul. 29, 2022
(86) PCT No.: PCT/US22/38857

§ 371 Date: Jan. 25, 2024

Related U.S. Application Data
(60) Provisional application No. 63/227,464, filed on Jul. 30, 2021.

(51) Int. Cl. G06N 3/094; G06N 3/045

(52) U.S. Cl. CPC G06N 3/094; G06N 3/045

(57) ABSTRACT

Methods for adversarial training and/or for analyzing the impact of fine-tuning on deep learning models may include receiving a deep learning model comprising a set of parameters and a dataset of samples. A respective noise vector for a respective sample may be generated based on a length of the sample and a radius hyperparameter. For a target number of steps, the following may be repeated: adjusting the noise vector based on a step size hyperparameter, and projecting the respective noise vector to be within a boundary. The parameters of the deep learning model may be adjusted based on a gradient of a loss based on the noise vector. This may be repeated for each sample of the plurality of samples. A system and computer program product are also disclosed.

### CROSS REFERENCE TO RELATED APPLICATIONS

This application is the United States national phase of International Application No. PCT/US2022/038857 filed Jul. 29, 2022, and claims the benefit of U.S. Provisional Patent Application No. 63/227,464, filed Jul. 30, 2021, the entire disclosures of which are incorporated by reference herein in their entirety.

### BACKGROUND

### 1. Technical Field

This disclosed subject matter relates generally to methods, systems, and computer program products for training and/or fine-tuning deep learning models and, in non-limiting embodiments or aspects, to a method, system, and computer program product for adversarial training and/or for analyzing the impact of fine-tuning on deep learning models.

### 2. Technical Considerations

Adversarial training can be used to train and/or fine-tune certain deep learning models. However, adversarial training techniques designed for certain deep learning models (e.g., models designed to perform particular tasks and/or having particular loss functions) may not be suitable for other deep learning models.

Additionally, a pre-trained model (e.g., a deep learning model that was previously trained to perform certain general purpose tasks) can be fine-tuned to better perform a specific task. However, fine-tuning may degrade the performance of the model in performing other tasks. For example, if a pre-trained natural language processing (NLP) model, which performs general NLP tasks (e.g., syntactic tasks, morphological tasks, and/or semantic tasks) well, is fine-tuned to perform a specific task, the performance of other general NLP tasks by that model may be reduced. Further, because of the complexity of deep learning models, it may be difficult to interpret and/or analyze the model, e.g., interpret and/or analyze the amount of degraded performance of general tasks when a model is fine-tuned to perform a specific task. Without being able to interpret and/or analyze the model, it may be difficult to understand the impact of certain types of fine-tuning (e.g., gradient descent, adversarial training, and/or the like) on performance of the model, e.g., the amount of degradation of the model in performing general tasks when the model is fine-tuned to perform specific tasks.

### SUMMARY

Accordingly, provided are improved methods, systems, and computer program products for adversarial training and/or for analyzing the impact of fine-tuning on deep learning models, thereby improving the efficiency with which computing resources are used to perform the specific task, in comparison to using the previously trained model.

According to non-limiting embodiments or aspects, provided is a method for adversarial training of deep learning models. In some non-limiting embodiments or aspects, a method for adversarial training of deep learning models may include receiving a deep learning model comprising a set of parameters and a dataset comprising a plurality of samples. A respective noise vector for a respective sample of the plurality of samples may be generated. The respective noise vector may be generated based on a length of the respective sample and a radius hyperparameter. The following may be repeated for a target number of steps: adjusting the respective noise vector based on a step size hyperparameter, and projecting the respective noise vector to be within a boundary based on the radius hyperparameter if the respective noise vector was adjusted beyond the boundary after adjusting the respective noise vector. The set of parameters of the deep learning model may be adjusted based on a gradient of a loss based on the respective noise vector. The generating, the repeating for the target number of steps, and the adjusting of the set of parameters may be repeated for each sample of the plurality of samples.

In some non-limiting embodiments or aspects, the deep learning model may include a natural language processing (NLP) model. For example, the NLP model may include a Bidirectional Encoder Representations from Transformers (BERT) model.

In some non-limiting embodiments or aspects, generating the respective noise vector may include generating the respective noise vector based on the following equation:

$$δ = \frac{1}{\sqrt{{L}_{i}}} U ( - ϵ , ϵ )$$

wherein δ is the noise vector, Lᵢ is the length of the respective sample, ϵ is the radius hyperparameter, and U(−ϵ, ϵ) is a uniform distribution from −ϵ to ϵ.

In some non-limiting embodiments or aspects, adjusting the respective noise vector may include adjusting the respective noise vector based on the following equation:

$$δ = δ + α \cdot \frac{{∇}_{δ} ℓ ( {f}_{θ} ( {x}_{i} + δ ) , {y}_{i} )}{‖ {∇}_{δ} ℓ ( {f}_{θ} ( {x}_{i} + δ ) , {y}_{i} ) ‖}$$

wherein δ is the noise vector, α is the step size hyperparameter, [symbol] ( ) is a loss function, ƒ_{θ}( ) is an output of the deep learning model, ∇_{δ} is the gradient of δ, and yᵢ is an expected output of the deep learning model.

In some non-limiting embodiments or aspects, projecting the respective noise vector may include projecting the respective noise vector based on the following equation:

$$δ = \frac{δ}{max ( 1 , \frac{‖ δ ‖}{ϵ} )}$$

wherein δ is the noise vector and ϵ is the radius hyperparameter.

In some non-limiting embodiments or aspects, adjusting the set of parameters may include adjusting the set of parameters based on the following equation:

$$θ = θ - {∇}_{θ} ℓ ( {f}_{θ} ( {x}_{i} + δ ) , {y}_{i} )$$

wherein δ is the noise vector, θ is the set of parameters, [symbol] ( ) is a loss function, ƒ_{θ}( ) is an output of the deep learning model, and yᵢ is an expected output of the deep learning model.

In some non-limiting embodiments or aspects, the following may be repeated for a target number of epochs: the repetition of the generating, the repeating for the target number of steps, and the adjusting of the set of parameters for each sample of the plurality of samples.

According to non-limiting embodiments or aspects, provided is a method for analyzing the impact of fine-tuning on deep learning models. In some non-limiting embodiments or aspects, a method for analyzing the impact of fine-tuning on deep learning models may include receiving a pre-trained deep learning model comprising a first set of parameters. The first set of parameters may be copied to provide a first deep learning model. The first deep learning model may be fine-tuned to perform a target task based on a first fine-tuning technique to provide a first fine-tuned deep learning model. The first set of parameters may be copied to provide a second deep learning model. The second deep learning model may be fine-tuned to perform the target task based on a second fine-tuning technique to provide a second fine-tuned deep learning model. A first divergence of the first fine-tuned deep learning model from the pre-trained deep learning model and a second divergence of the second fine-tuned deep learning model from the pre-trained deep learning model may be determined. At least one parameter-free task may be performed with each of the pre-trained deep learning model, the first fine-tuned deep learning model, and the second fine-tuned deep learning model. At least one parametric task may be performed with each of the pre-trained deep learning model, the first fine-tuned deep learning model, and the second fine-tuned deep learning model. At least one intrinsic metric for each of the first fine-tuned deep learning model and the second fine-tuned deep learning model may be determined. The first fine-tuned deep learning model and the second fine-tuned deep learning model may be compared based on determining of the first divergence and the second divergence, performing the at least one parameter-free task, performing the at least one parametric task, and determining the at least one intrinsic metric.

In some non-limiting embodiments or aspects, determining the first divergence may include determining a first symmetrized Kullback-Leibler (KL) divergence based on the first fine-tuned deep learning model and the pre-trained deep learning model. Additionally or alternatively, determining the second divergence may include determining a second symmetrized KL divergence based on the second fine-tuned deep learning model and the pre-trained deep learning model.

In some non-limiting embodiments or aspects, the pre-trained deep learning model may include a BERT model. Additionally or alternatively, performing the at least one parameter-free task may include performing at least one of a syntactic task or a morphological task based on masking a word of at least one input sample with each of the pre-trained deep learning model, the first fine-tuned deep learning model, and the second fine-tuned deep learning model.

In some non-limiting embodiments or aspects, the pre-trained deep learning model may include a BERT model. Additionally or alternatively, performing the at least one parametric task may include performing at least one of part of speech (POS) tagging, dependency arc labeling, or dependency parsing with each of the pre-trained deep learning model, the first fine-tuned deep learning model, and the second fine-tuned deep learning model.

In some non-limiting embodiments or aspects, determining the at least one intrinsic metric may include determining at least one of a first metric based on gradient-based analysis or a second metric based on singular value decomposition (SVD)-based analysis for each of the first fine-tuned deep learning model and the second fine-tuned deep learning model.

In some non-limiting embodiments or aspects, comparing the first fine-tuned deep learning model and the second fine-tuned deep learning model may include displaying at least one first graph based on determining of the first divergence and the second divergence, displaying at least one first table based on performing the at least one parameter-free task, displaying at least one second table and/or at least one second graph based on performing the at least one parametric task, and/or displaying at least one third graph based on determining the at least one intrinsic metric.

In some non-limiting embodiments or aspects, based on the comparing, one of the first fine-tuned deep learning model and the second fine-tuned deep learning model may be executed. Additionally or alternatively, the second fine-tuning technique may include any of the techniques for adversarial training of deep learning models described herein.

According to non-limiting embodiments or aspects, provided is a system for adversarial training of deep learning models. In some non-limiting embodiments or aspects, the system for adversarial training of deep learning models may include at least one processor and at least one non-transitory computer-readable medium including one or more instructions that, when executed by the at least one processor, direct the at least one processor to receive a deep learning model comprising a set of parameters and a dataset comprising a plurality of samples. A respective noise vector for a respective sample of the plurality of samples may be generated. The respective noise vector may be generated based on a length of the respective sample and a radius hyperparameter. The following may be repeated for a target number of steps: adjusting the respective noise vector based on a step size hyperparameter, and projecting the respective noise vector to be within a boundary based on the radius hyperparameter if the respective noise vector was adjusted beyond the boundary after adjusting the respective noise vector. The set of parameters of the deep learning model may be adjusted based on a gradient of a loss based on the respective noise vector. The generating, the repeating for the target number of steps, and the adjusting of the set of parameters may be repeated for each sample of the plurality of samples.

In some non-limiting embodiments or aspects, the deep learning model may include a natural language processing (NLP) model. For example, the NLP model may include a Bidirectional Encoder Representations from Transformers (BERT) model.

In some non-limiting embodiments or aspects, generating the respective noise vector may include generating the respective noise vector based on the following equation:

$$δ = \frac{1}{\sqrt{{L}_{i}}} U ( - ϵ , ϵ )$$

wherein δ is the noise vector, Lᵢ is the length of the respective sample, ϵ is the radius hyperparameter, and U(−ϵ, ϵ) is a uniform distribution from −ϵ to ϵ.

In some non-limiting embodiments or aspects, adjusting the respective noise vector may include adjusting the respective noise vector based on the following equation:

$$δ = δ + α \cdot \frac{{∇}_{δ} ℓ ( {f}_{θ} ( {x}_{i} + δ ) , {y}_{i} )}{‖ {∇}_{δ} ℓ ( {f}_{θ} ( {x}_{i} + δ ) , {y}_{i} ) ‖}$$

wherein δ is the noise vector, α is the step size hyperparameter, [symbol] ( ) is a loss function, ƒ_{θ}( ) is an output of the deep learning model, ∇_{δ} is the gradient of δ, and yᵢ is an expected output of the deep learning model.

In some non-limiting embodiments or aspects, projecting the respective noise vector may include projecting the respective noise vector based on the following equation:

$$δ = \frac{δ}{max ( 1 , \frac{‖ δ ‖}{ϵ} )}$$

wherein δ is the noise vector and ϵ is the radius hyperparameter.

In some non-limiting embodiments or aspects, adjusting the set of parameters may include adjusting the set of parameters based on the following equation:

$$θ = θ - {∇}_{θ} ℓ ( {f}_{θ} ( {x}_{i} + δ ) , {y}_{i} )$$

wherein δ is the noise vector, θ is the set of parameters, [symbol] ( ) is a loss function, ƒ_{θ}( ) is an output of the deep learning model, and yᵢ is an expected output of the deep learning model.

In some non-limiting embodiments or aspects, the following may be repeated for a target number of epochs: the repetition of the generating, the repeating for the target number of steps, and the adjusting of the set of parameters for each sample of the plurality of samples.

According to non-limiting embodiments or aspects, provided is a computer program product for adversarial training of deep learning models. The computer program product may include at least one non-transitory computer-readable medium including one or more instructions that, when executed by at least one processor, cause the at least one processor to receive a deep learning model comprising a set of parameters and a dataset comprising a plurality of samples. A respective noise vector for a respective sample of the plurality of samples may be generated. The respective noise vector may be generated based on a length of the respective sample and a radius hyperparameter. The following may be repeated for a target number of steps: adjusting the respective noise vector based on a step size hyperparameter, and projecting the respective noise vector to be within a boundary based on the radius hyperparameter if the respective noise vector was adjusted beyond the boundary after adjusting the respective noise vector. The set of parameters of the deep learning model may be adjusted based on a gradient of a loss based on the respective noise vector. The generating, the repeating for the target number of steps, and the adjusting of the set of parameters may be repeated for each sample of the plurality of samples.

In some non-limiting embodiments or aspects, the deep learning model may include a natural language processing (NLP) model. For example, the NLP model may include a Bidirectional Encoder Representations from Transformers (BERT) model.

In some non-limiting embodiments or aspects, generating the respective noise vector may include generating the respective noise vector based on the following equation:

$$δ = \frac{1}{\sqrt{{L}_{i}}} U ( - ϵ , ϵ )$$

wherein δ is the noise vector, Lᵢ is the length of the respective sample, ϵ is the radius hyperparameter, and U(−ϵ, ϵ) is a uniform distribution from −ϵ to ϵ.

In some non-limiting embodiments or aspects, adjusting the respective noise vector may include adjusting the respective noise vector based on the following equation:

$$δ = δ + α \cdot \frac{{∇}_{δ} ℓ ( {f}_{θ} ( {x}_{i} + δ ) , {y}_{i} )}{‖ {∇}_{δ} ℓ ( {f}_{θ} ( {x}_{i} + δ ) , {y}_{i} ) ‖}$$

wherein δ is the noise vector, α is the step size hyperparameter, [symbol] ( ) is a loss function, ƒ_{θ}( ) is an output of the deep learning model, ∇_{δ} is the gradient of δ, and yᵢ is an expected output of the deep learning model.

In some non-limiting embodiments or aspects, projecting the respective noise vector may include projecting the respective noise vector based on the following equation:

$$δ = \frac{δ}{max ( 1 , \frac{‖ δ ‖}{ϵ} )}$$

wherein δ is the noise vector and ϵ is the radius hyperparameter.

In some non-limiting embodiments or aspects, adjusting the set of parameters may include adjusting the set of parameters based on the following equation:

$$θ = θ - {∇}_{θ} ℓ ( {f}_{θ} ( {x}_{i} + δ ) , {y}_{i} )$$

wherein δ is the noise vector, θ is the set of parameters, [symbol] ( ) is a loss function, ƒ_{θ}( ) is an output of the deep learning model, and yᵢ is an expected output of the deep learning model.

In some non-limiting embodiments or aspects, the following may be repeated for a target number of epochs: the repetition of the generating, the repeating for the target number of steps, and the adjusting of the set of parameters for each sample of the plurality of samples.

According to non-limiting embodiments or aspects, provided is a system for analyzing the impact of fine-tuning on deep learning models. In some non-limiting embodiments or aspects, the system for analyzing the impact of fine-tuning on deep learning models may include at least one processor and at least one non-transitory computer-readable medium including one or more instructions that, when executed by the at least one processor, direct the at least one processor to receive a pre-trained deep learning model comprising a first set of parameters. The first set of parameters may be copied to provide a first deep learning model. The first deep learning model may be fine-tuned to perform a target task based on a first fine-tuning technique to provide a first fine-tuned deep learning model. The first set of parameters may be copied to provide a second deep learning model. The second deep learning model may be fine-tuned to perform the target task based on a second fine-tuning technique to provide a second fine-tuned deep learning model. A first divergence of the first fine-tuned deep learning model from the pre-trained deep learning model and a second divergence of the second fine-tuned deep learning model from the pre-trained deep learning model may be determined. At least one parameter-free task may be performed with each of the pre-trained deep learning model, the first fine-tuned deep learning model, and the second fine-tuned deep learning model. At least one parametric task may be performed with each of the pre-trained deep learning model, the first fine-tuned deep learning model, and the second fine-tuned deep learning model. At least one intrinsic metric for each of the first fine-tuned deep learning model and the second fine-tuned deep learning model may be determined. The first fine-tuned deep learning model and the second fine-tuned deep learning model may be compared based on determining of the first divergence and the second divergence, performing the at least one parameter-free task, performing the at least one parametric task, and determining the at least one intrinsic metric.

In some non-limiting embodiments or aspects, determining the first divergence may include determining a first symmetrized Kullback-Leibler (KL) divergence based on the first fine-tuned deep learning model and the pre-trained deep learning model. Additionally or alternatively, determining the second divergence may include determining a second symmetrized KL divergence based on the second fine-tuned deep learning model and the pre-trained deep learning model.

In some non-limiting embodiments or aspects, the pre-trained deep learning model may include a BERT model. Additionally or alternatively, performing the at least one parameter-free task may include performing at least one of a syntactic task or a morphological task based on masking a word of at least one input sample with each of the pre-trained deep learning model, the first fine-tuned deep learning model, and the second fine-tuned deep learning model.

In some non-limiting embodiments or aspects, the pre-trained deep learning model may include a BERT model. Additionally or alternatively, performing the at least one parametric task may include performing at least one of part of speech (POS) tagging, dependency arc labeling, or dependency parsing with each of the pre-trained deep learning model, the first fine-tuned deep learning model, and the second fine-tuned deep learning model.

In some non-limiting embodiments or aspects, determining the at least one intrinsic metric may include determining at least one of a first metric based on gradient-based analysis or a second metric based on singular value decomposition (SVD)-based analysis for each of the first fine-tuned deep learning model and the second fine-tuned deep learning model.

In some non-limiting embodiments or aspects, comparing the first fine-tuned deep learning model and the second fine-tuned deep learning model may include displaying at least one first graph based on determining of the first divergence and the second divergence, displaying at least one first table based on performing the at least one parameter-free task, displaying at least one second table and/or at least one second graph based on performing the at least one parametric task, and/or displaying at least one third graph based on determining the at least one intrinsic metric.

According to non-limiting embodiments or aspects, provided is a computer program product for analyzing the impact of fine-tuning on deep learning models. The computer program product may include at least one non-transitory computer-readable medium including one or more instructions that, when executed by at least one processor, cause the at least one processor to receive a pre-trained deep learning model comprising a first set of parameters. The first set of parameters may be copied to provide a first deep learning model. The first deep learning model may be fine-tuned to perform a target task based on a first fine-tuning technique to provide a first fine-tuned deep learning model. The first set of parameters may be copied to provide a second deep learning model. The second deep learning model may be fine-tuned to perform the target task based on a second fine-tuning technique to provide a second fine-tuned deep learning model. A first divergence of the first fine-tuned deep learning model from the pre-trained deep learning model and a second divergence of the second fine-tuned deep learning model from the pre-trained deep learning model may be determined. At least one parameter-free task may be performed with each of the pre-trained deep learning model, the first fine-tuned deep learning model, and the second fine-tuned deep learning model. At least one parametric task may be performed with each of the pre-trained deep learning model, the first fine-tuned deep learning model, and the second fine-tuned deep learning model. At least one intrinsic metric for each of the first fine-tuned deep learning model and the second fine-tuned deep learning model may be determined. The first fine-tuned deep learning model and the second fine-tuned deep learning model may be compared based on determining of the first divergence and the second divergence, performing the at least one parameter-free task, performing the at least one parametric task, and determining the at least one intrinsic metric.

In some non-limiting embodiments or aspects, determining the first divergence may include determining a first symmetrized Kullback-Leibler (KL) divergence based on the first fine-tuned deep learning model and the pre-trained deep learning model. Additionally or alternatively, determining the second divergence may include determining a second symmetrized KL divergence based on the second fine-tuned deep learning model and the pre-trained deep learning model.

In some non-limiting embodiments or aspects, the pre-trained deep learning model may include a BERT model. Additionally or alternatively, performing the at least one parameter-free task may include performing at least one of a syntactic task or a morphological task based on masking a word of at least one input sample with each of the pre-trained deep learning model, the first fine-tuned deep learning model, and the second fine-tuned deep learning model.

In some non-limiting embodiments or aspects, the pre-trained deep learning model may include a BERT model. Additionally or alternatively, performing the at least one parametric task may include performing at least one of part of speech (POS) tagging, dependency arc labeling, or dependency parsing with each of the pre-trained deep learning model, the first fine-tuned deep learning model, and the second fine-tuned deep learning model.

In some non-limiting embodiments or aspects, determining the at least one intrinsic metric may include determining at least one of a first metric based on gradient-based analysis or a second metric based on singular value decomposition (SVD)-based analysis for each of the first fine-tuned deep learning model and the second fine-tuned deep learning model.

In some non-limiting embodiments or aspects, comparing the first fine-tuned deep learning model and the second fine-tuned deep learning model may include displaying at least one first graph based on determining of the first divergence and the second divergence, displaying at least one first table based on performing the at least one parameter-free task, displaying at least one second table and/or at least one second graph based on performing the at least one parametric task, and/or displaying at least one third graph based on determining the at least one intrinsic metric.

According to non-limiting embodiments or aspects, provided is a system for adversarial training and/or for analyzing the impact of fine-tuning on deep learning models. In some non-limiting embodiments or aspects, the system for adversarial training and/or for analyzing the impact of fine-tuning on deep learning models may include at least one processor and at least one non-transitory computer-readable medium including one or more instructions that, when executed by the at least one processor, direct the at least one processor to perform any of the methods described herein.

According to non-limiting embodiments or aspects, provided is a computer program product for adversarial training and/or for analyzing the impact of fine-tuning on deep learning models. The computer program product may include at least one non-transitory computer-readable medium including one or more instructions that, when executed by at least one processor, cause the at least one processor to perform any of the methods described herein.

Further non-limiting embodiments or aspects are set forth in the following numbered clauses:
Clause 1: A computer-implemented method, comprising: receiving, with at least one processor, a deep learning model comprising a set of parameters and a dataset comprising a plurality of samples; generating, with at least one processor, a respective noise vector for a respective sample of the plurality of samples, the respective noise vector generated based on a length of the respective sample and a radius hyperparameter; repeating, with at least one processor, for a target number of steps:

adjusting, with at least one processor, the respective noise vector based on a step size hyperparameter; and projecting, with at least one processor, the respective noise vector to be within a boundary based on the radius hyperparameter if the respective noise vector was adjusted beyond the boundary after adjusting the respective noise vector; adjusting, with at least one processor, the set of parameters of the deep learning model based on a gradient of a loss based on the respective noise vector; and repeating, with at least one processor, the generating, the repeating for the target number of steps, and the adjusting of the set of parameters for each sample of the plurality of samples.
Clause 2: The method of clause 1, wherein the deep learning model comprises a natural language processing (NLP) model.
Clause 3: The method of clause 1 or clause 2, wherein the NLP model comprises a Bidirectional Encoder Representations from Transformers (BERT) model.
Clause 4: The method of any of clauses 1-3, wherein generating the respective noise vector comprises generating the respective noise vector based on the following equation:

$$δ = \frac{1}{\sqrt{{L}_{i}}} U ( - ϵ , ϵ )$$

wherein δ comprises the noise vector, Lᵢ comprises the length of the respective sample, ϵ comprises the radius hyperparameter, and U(−ϵ, ϵ) comprises a uniform distribution from −ϵ to ϵ.
Clause 5: The method of any of clauses 1-4, wherein adjusting the respective noise vector comprises adjusting the respective noise vector based on the following equation:

$$δ = δ + α \cdot \frac{{∇}_{δ} ℓ ( {f}_{θ} ( {x}_{i} + δ ) , {y}_{i} )}{‖ {∇}_{δ} ℓ ( {f}_{θ} ( {x}_{i} + δ ) , {y}_{i} ) ‖}$$

wherein δ comprises the noise vector, α comprises the step size hyperparameter, [symbol] ( ) comprises a loss function, ƒ_{θ}( ) comprises an output of the deep learning model, ∇_{δ} is the gradient of δ, and yᵢ comprises an expected output of the deep learning model.
Clause 6: The method of any of clauses 1-5, wherein projecting the respective noise vector comprises projecting the respective noise vector based on the following equation:

$$δ = \frac{δ}{max ( 1 , \frac{‖ δ ‖}{ϵ} )}$$

wherein δ comprises the noise vector and ϵ comprises the radius hyperparameter.
Clause 7: The method of any of clauses 1-6, wherein adjusting the set of parameters comprises adjusting the set of parameters based on the following equation:

$$θ = θ - {∇}_{θ} ℓ ( {f}_{θ} ( {x}_{i} + δ ) , {y}_{i} )$$

wherein δ comprises the noise vector, θ comprises the set of parameters, [symbol] ( ) comprises a loss function, ƒ_{θ}( ) comprises an output of the deep learning model, and yᵢ comprises an expected output of the deep learning model.
Clause 8: The method of any of clauses 1-7, further comprising: repeating, with at least one processor, for a target number of epochs, the repetition of the generating, the repeating for the target number of steps, and the adjusting of the set of parameters for each sample of the plurality of samples.
Clause 9: A computer-implemented method, comprising: receiving, with at least one processor, a pre-trained deep learning model comprising a first set of parameters; copying, with at least one processor, the first set of parameters to provide a first deep learning model; fine-tuning, with at least one processor, the first deep learning model to perform a target task based on a first fine-tuning technique to provide a first fine-tuned deep learning model; copying, with at least one processor, the first set of parameters to provide a second deep learning model; fine-tuning, with at least one processor, the second deep learning model to perform the target task based on a second fine-tuning technique to provide a second fine-tuned deep learning model; determining, with at least one processor, a first divergence of the first fine-tuned deep learning model from the pre-trained deep learning model and a second divergence of the second fine-tuned deep learning model from the pre-trained deep learning model; performing, with at least one processor, at least one parameter-free task with each of the pre-trained deep learning model, the first fine-tuned deep learning model, and the second fine-tuned deep learning model; performing, with at least one processor, at least one parametric task with each of the pre-trained deep learning model, the first fine-tuned deep learning model, and the second fine-tuned deep learning model; determining, with at least one processor, at least one intrinsic metric for each of the first fine-tuned deep learning model and the second fine-tuned deep learning model; and comparing, with at least one processor, the first fine-tuned deep learning model and the second fine-tuned deep learning model based on determining of the first divergence and the second divergence, performing the at least one parameter-free task, performing the at least one parametric task, and determining the at least one intrinsic metric.
Clause 10: The method of clause 9, wherein determining the first divergence comprises determining a first symmetrized Kullback-Leibler (KL) divergence based on the first fine-tuned deep learning model and the pre-trained deep learning model, and wherein determining the second divergence comprises determining a second symmetrized KL divergence based on the second fine-tuned deep learning model and the pre-trained deep learning model.
Clause 11: The method of clause 9 or clause 10, wherein the pre-trained deep learning model comprises a Bidirectional Encoder Representations from Transformers (BERT) model, and wherein performing the at least one parameter-free task comprises performing at least one of a syntactic task or a morphological task based on masking a word of at least one input sample with each of the pre-trained deep learning model, the first fine-tuned deep learning model, and the second fine-tuned deep learning model.
Clause 12: The method of any of clauses 9-11, wherein the pre-trained deep learning model comprises a Bidirectional Encoder Representations from Transformers (BERT) model, and wherein performing the at least one parametric task comprises performing at least one of part of speech (POS) tagging, dependency arc labeling, or dependency parsing with each of the pre-trained deep learning model, the first fine-tuned deep learning model, and the second fine-tuned deep learning model.
Clause 13: The method of any of clauses 9-12, wherein determining the at least one intrinsic metric comprises determining at least one of a first metric based on gradient-based analysis or a second metric based on singular value decomposition (SVD)-based analysis for each of the first fine-tuned deep learning model and the second fine-tuned deep learning model.
Clause 14: The method of any of clauses 9-14, wherein comparing the first fine-tuned deep learning model and the second fine-tuned deep learning model comprises displaying at least one first graph based on determining of the first divergence and the second divergence, displaying at least one first table based on performing the at least one parameter-free task, displaying at least one second table and/or at least one second graph based on performing the at least one parametric task, and/or displaying at least one third graph based on determining the at least one intrinsic metric.
Clause 15: The method of any of clauses 9-14, further comprising: executing, with at least one processor and based on the comparing, one of the first fine-tuned deep learning model and the second fine-tuned deep learning model, wherein: the second fine-tuning technique comprises the method of any of claims 1-8.
Clause 16: A system comprising: at least one processor; and at least one non-transitory computer-readable medium including one or more instructions that, when executed by the at least one processor, direct the at least one processor to perform the method of claim 15.
Clause 17: A computer program product comprising at least one non-transitory computer-readable medium including one or more instructions that, when executed by at least one processor, cause the at least one processor to perform the method of claim 15.
Clause 18: A system, comprising: at least one processor; and at least one non-transitory computer-readable medium including one or more instructions that, when executed by the at least one processor, direct the at least one processor to: receive a deep learning model comprising a set of parameters and a dataset comprising a plurality of samples; generate a respective noise vector for a respective sample of the plurality of samples, the respective noise vector generated based on a length of the respective sample and a radius hyperparameter; repeat for a target number of steps: adjust the respective noise vector based on a step size hyperparameter; and project the respective noise vector to be within a boundary based on the radius hyperparameter if the respective noise vector was adjusted beyond the boundary after adjusting the respective noise vector; adjust the set of parameters of the deep learning model based on a gradient of a loss based on the respective noise vector; and repeat the generating, the repeating for the target number of steps, and the adjusting of the set of parameters for each sample of the plurality of samples.
Clause 19: A computer program product comprising at least one non-transitory computer-readable medium including one or more instructions that, when executed by at least one processor, cause the at least one processor to: receive a deep learning model comprising a set of parameters and a dataset comprising a plurality of samples; generate a respective noise vector for a respective sample of the plurality of samples, the respective noise vector generated based on a length of the respective sample and a radius hyperparameter; repeat for a target number of steps: adjust the respective noise vector based on a step size hyperparameter; and project the respective noise vector to be within a boundary based on the radius hyperparameter if the respective noise vector was adjusted beyond the boundary after adjusting the respective noise vector; adjust the set of parameters of the deep learning model based on a gradient of a loss based on the respective noise vector; and repeat the generating, the repeating for the target number of steps, and the adjusting of the set of parameters for each sample of the plurality of samples.
Clause 20: A system, comprising: at least one processor; and at least one non-transitory computer-readable medium including one or more instructions that, when executed by the at least one processor, direct the at least one processor to: receive a pre-trained deep learning model comprising a first set of parameters; copy the first set of parameters to provide a first deep learning model; fine-tune the first deep learning model to perform a target task based on a first fine-tuning technique to provide a first fine-tuned deep learning model; copy the first set of parameters to provide a second deep learning model; fine-tune the second deep learning model to perform the target task based on a second fine-tuning technique to provide a second fine-tuned deep learning model; determine a first divergence of the first fine-tuned deep learning model from the pre-trained deep learning model and a second divergence of the second fine-tuned deep learning model from the pre-trained deep learning model; perform at least one parameter-free task with each of the pre-trained deep learning model, the first fine-tuned deep learning model, and the second fine-tuned deep learning model; perform at least one parametric task with each of the pre-trained deep learning model, the first fine-tuned deep learning model, and the second fine-tuned deep learning model; determine at least one intrinsic metric for each of the first fine-tuned deep learning model and the second fine-tuned deep learning model; and compare the first fine-tuned deep learning model and the second fine-tuned deep learning model based on determining of the first divergence and the second divergence, performing the at least one parameter-free task, performing the at least one parametric task, and determining the at least one intrinsic metric.
Clause 21: A computer program product comprising at least one non-transitory computer-readable medium including one or more instructions that, when executed by at least one processor, cause the at least one processor to: receive a pre-trained deep learning model comprising a first set of parameters; copy the first set of parameters to provide a first deep learning model; fine-tune the first deep learning model to perform a target task based on a first fine-tuning technique to provide a first fine-tuned deep learning model; copy the first set of parameters to provide a second deep learning model; fine-tune the second deep learning model to perform the target task based on a second fine-tuning technique to provide a second fine-tuned deep learning model; determine a first divergence of the first fine-tuned deep learning model from the pre-trained deep learning model and a second divergence of the second fine-tuned deep learning model from the pre-trained deep learning model; perform at least one parameter-free task with each of the pre-trained deep learning model, the first fine-tuned deep learning model, and the second fine-tuned deep learning model; perform at least one parametric task with each of the pre-trained deep learning model, the first fine-tuned deep learning model, and the second fine-tuned deep learning model; determine at least one intrinsic metric for each of the first fine-tuned deep learning model and the second fine-tuned deep learning model; and compare the first fine-tuned deep learning model and the second fine-tuned deep learning model based on determining of the first divergence and the second divergence, performing the at least one parameter-free task, performing the at least one parametric task, and determining the at least one intrinsic metric.
Clause 22: A system, comprising: at least one processor; and at least one non-transitory computer-readable medium including one or more instructions that, when executed by the at least one processor, direct the at least one processor to perform the method of any one of clauses 1-15.
Clause 23: A computer program product comprising at least one non-transitory computer-readable medium including one or more instructions that, when executed by at least one processor, cause the at least one processor to perform the method of any one of clauses 1-15.

These and other features and characteristics of the presently disclosed subject matter, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter. As used in the specification and the claims, the singular form of “a,” “an,” and “the” include plural referents unless the context clearly dictates otherwise.

### BRIEF DESCRIPTION OF THE DRAWINGS

Additional advantages and details of the disclosed subject matter are explained in greater detail below with reference to the exemplary embodiments or aspects that are illustrated in the accompanying figures, in which:

FIG. 1 is a diagram of an exemplary system for adversarial training and/or for analyzing the impact of fine-tuning on deep learning models, according to some non-limiting embodiments or aspects of the presently disclosed subject matter;

FIG. 2A is a flowchart of an exemplary process for adversarial training of deep learning models, according to some non-limiting embodiments or aspects of the presently disclosed subject matter;

FIG. 2B is a flowchart of an exemplary process for analyzing the impact of fine-tuning on deep learning models, according to some non-limiting embodiments or aspects of the presently disclosed subject matter;

FIG. 3 is a diagram of an exemplary environment in which methods, systems, and/or computer program products, described herein, may be implemented, according to some non-limiting embodiments or aspects of the presently disclosed subject matter;

FIG. 4 is a diagram of exemplary components of one or more devices of FIG. 1 and/or FIG. 3, according to some non-limiting embodiments or aspects of the presently disclosed subject matter;

FIGS. 5A-5D are graphs showing performance of exemplary implementations of the techniques described herein, according to some non-limiting embodiments or aspects of the presently disclosed subject matter;

FIGS. 6A-6D are graphs showing performance of exemplary implementations of the techniques described herein, according to some non-limiting embodiments or aspects of the presently disclosed subject matter;

FIGS. 7A-7D are graphs showing performance of exemplary implementations of the techniques described herein, according to some non-limiting embodiments or aspects of the presently disclosed subject matter;

FIGS. 8A-8C are diagrams of exemplary dependency arc labeling based on exemplary implementations of the techniques described herein, according to some non-limiting embodiments or aspects of the presently disclosed subject matter; and

FIGS. 9A-9D are graphs showing performance of exemplary implementations of the techniques described herein, according to some non-limiting embodiments or aspects of the presently disclosed subject matter.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosed subject matter as it is oriented in the drawing figures. However, it is to be understood that the disclosed subject matter may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting unless otherwise indicated.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the terms “issuer institution,” “portable financial device issuer,” “issuer,” or “issuer bank” may refer to one or more entities that provide accounts to customers for conducting transactions (e.g., payment transactions), such as initiating credit and/or debit payments. For example, an issuer institution may provide an account identifier, such as a primary account number (PAN), to a customer that uniquely identifies one or more accounts associated with that customer. The account identifier may be embodied on a portable financial device, such as a physical financial instrument, e.g., a payment card, and/or may be electronic and used for electronic payments. The terms “issuer institution” and “issuer institution system” may also refer to one or more computer systems operated by or on behalf of an issuer institution, such as a server computer executing one or more software applications. For example, an issuer institution system may include one or more authorization servers for authorizing a transaction.

As used herein, the term “account identifier” may include one or more types of identifiers associated with a user account (e.g., a PAN, a card number, a payment card number, a payment token, and/or the like). In some non-limiting embodiments or aspects, an issuer institution may provide an account identifier (e.g., a PAN, a payment token, and/or the like) to a user that uniquely identifies one or more accounts associated with that user. The account identifier may be embodied on a physical financial instrument (e.g., a portable financial instrument, a payment card, a credit card, a debit card, and/or the like) and/or may be electronic information communicated to the user that the user may use for electronic payments. In some non-limiting embodiments or aspects, the account identifier may be an original account identifier, where the original account identifier was provided to a user at the creation of the account associated with the account identifier. In some non-limiting embodiments or aspects, the account identifier may be an account identifier (e.g., a supplemental account identifier) that is provided to a user after the original account identifier was provided to the user. For example, if the original account identifier is forgotten, stolen, and/or the like, a supplemental account identifier may be provided to the user. In some non-limiting embodiments or aspects, an account identifier may be directly or indirectly associated with an issuer institution such that an account identifier may be a payment token that maps to a PAN or other type of identifier. Account identifiers may be alphanumeric, any combination of characters and/or symbols, and/or the like. An issuer institution may be associated with a bank identification number (BIN) that uniquely identifies the issuer institution.

As used herein, the terms “payment token” or “token” may refer to an identifier that is used as a substitute or replacement identifier for an account identifier, such as a PAN. Tokens may be associated with a PAN or other account identifiers in one or more data structures (e.g., one or more databases and/or the like) such that they can be used to conduct a transaction (e.g., a payment transaction) without directly using the account identifier, such as a PAN. In some examples, an account identifier, such as a PAN, may be associated with a plurality of tokens for different individuals, different uses, and/or different purposes. For example, a payment token may include a series of numeric and/or alphanumeric characters that may be used as a substitute for an original account identifier. For example, a payment token “4900 0000 0000 0001” may be used in place of a PAN “4147 0900 0000 1234.” In some non-limiting embodiments or aspects, a payment token may be “format preserving” and may have a numeric format that conforms to the account identifiers used in existing payment processing networks (e.g., ISO 8583 financial transaction message format). In some non-limiting embodiments or aspects, a payment token may be used in place of a PAN to initiate, authorize, settle, or resolve a payment transaction or represent the original credential in other systems where the original credential would typically be provided. In some non-limiting embodiments or aspects, a token value may be generated such that the recovery of the original PAN or other account identifier from the token value may not be computationally derived (e.g., with a one-way hash or other cryptographic function). Further, in some non-limiting embodiments or aspects, the token format may be configured to allow the entity receiving the payment token to identify it as a payment token and recognize the entity that issued the token.

As used herein, the term “provisioning” may refer to a process of enabling a device to use a resource or service. For example, provisioning may involve enabling a device to perform transactions using an account. Additionally or alternatively, provisioning may include adding provisioning data associated with account data (e.g., a payment token representing an account number) to a device.

As used herein, the term “token requestor” may refer to an entity that is seeking to implement tokenization according to embodiments or aspects of the presently disclosed subject matter. For example, the token requestor may initiate a request that a PAN be tokenized by submitting a token request message to a token service provider. Additionally or alternatively, a token requestor may no longer need to store a PAN associated with a token once the requestor has received the payment token in response to a token request message. In some non-limiting embodiments or aspects, the requestor may be an application, a device, a process, or a system that is configured to perform actions associated with tokens. For example, a requestor may request registration with a network token system, request token generation, token activation, token de-activation, token exchange, other token lifecycle management related processes, and/or any other token related processes. In some non-limiting embodiments or aspects, a requestor may interface with a network token system through any suitable communication network and/or protocol (e.g., using HTTPS, SOAP, and/or an XML interface among others). For example, a token requestor may include card-on-file merchants, acquirers, acquirer processors, payment gateways acting on behalf of merchants, payment enablers (e.g., original equipment manufacturers, mobile network operators, and/or the like), digital wallet providers, issuers, third-party wallet providers, payment processing networks, and/or the like. In some non-limiting embodiments or aspects, a token requestor may request tokens for multiple domains and/or channels. Additionally or alternatively, a token requestor may be registered and identified uniquely by the token service provider within the tokenization ecosystem. For example, during token requestor registration, the token service provider may formally process a token requestor's application to participate in the token service system. In some non-limiting embodiments or aspects, the token service provider may collect information pertaining to the nature of the requestor and relevant use of tokens to validate and formally approve the token requestor and establish appropriate domain restriction controls. Additionally or alternatively, successfully registered token requestors may be assigned a token requestor identifier that may also be entered and maintained within the token vault. In some non-limiting embodiments or aspects, token requestor identifiers may be revoked and/or token requestors may be assigned new token requestor identifiers. In some non-limiting embodiments or aspects, this information may be subject to reporting and audit by the token service provider.

As used herein, the term a “token service provider” may refer to an entity including one or more server computers in a token service system that generates, processes and maintains payment tokens. For example, the token service provider may include or be in communication with a token vault where the generated tokens are stored. Additionally or alternatively, the token vault may maintain one-to-one mapping between a token and a PAN represented by the token. In some non-limiting embodiments or aspects, the token service provider may have the ability to set aside licensed BINs as token BINs to issue tokens for the PANs that may be submitted to the token service provider. In some non-limiting embodiments or aspects, various entities of a tokenization ecosystem may assume the roles of the token service provider. For example, payment networks and issuers or their agents may become the token service provider by implementing the token services according to non-limiting embodiments or aspects of the presently disclosed subject matter. Additionally or alternatively, a token service provider may provide reports or data output to reporting tools regarding approved, pending, or declined token requests, including any assigned token requestor ID. The token service provider may provide data output related to token-based transactions to reporting tools and applications and present the token and/or PAN as appropriate in the reporting output. In some non-limiting embodiments or aspects, the EMVCo standards organization may publish specifications defining how tokenized systems may operate. For example, such specifications may be informative, but they are not intended to be limiting upon any of the presently disclosed subject matter.

As used herein, the term “token vault” may refer to a repository that maintains established token-to-PAN mappings. For example, the token vault may also maintain other attributes of the token requestor that may be determined at the time of registration and/or that may be used by the token service provider to apply domain restrictions or other controls during transaction processing. In some non-limiting embodiments or aspects, the token vault may be a part of a token service system. For example, the token vault may be provided as a part of the token service provider. Additionally or alternatively, the token vault may be a remote repository accessible by the token service provider. In some non-limiting embodiments or aspects, token vaults, due to the sensitive nature of the data mappings that are stored and managed therein, may be protected by strong underlying physical and logical security. Additionally or alternatively, a token vault may be operated by any suitable entity, including a payment network, an issuer, clearing houses, other financial institutions, transaction service providers, and/or the like.

As used herein, the term “merchant” may refer to one or more entities (e.g., operators of retail businesses that provide goods and/or services, and/or access to goods and/or services, to a user (e.g., a customer, a consumer, a customer of the merchant, and/or the like) based on a transaction (e.g., a payment transaction)). As used herein, the term “merchant system” may refer to one or more computer systems operated by or on behalf of a merchant, such as a server computer executing one or more software applications. As used herein, the term “product” may refer to one or more goods and/or services offered by a merchant.

As used herein, the term “point-of-sale device” may refer to one or more devices, which may be used by a merchant to initiate transactions (e.g., a payment transaction), engage in transactions, and/or process transactions. For example, a point-of-sale device may include one or more computers, peripheral devices, card readers, near-field communication (NFC) receivers, radio frequency identification (RFID) receivers, and/or other contactless transceivers or receivers, contact-based receivers, payment terminals, computers, servers, input devices, and/or the like.

As used herein, the term “point-of-sale system” may refer to one or more computers and/or peripheral devices used by a merchant to conduct a transaction. For example, a point-of-sale system may include one or more point-of-sale devices and/or other like devices that may be used to conduct a payment transaction. A point-of-sale system (e.g., a merchant point-of-sale system) may also include one or more server computers programmed or configured to process online payment transactions through webpages, mobile applications, and/or the like.

As used herein, the term “transaction service provider” may refer to an entity that receives transaction authorization requests from merchants or other entities and provides guarantees of payment, in some cases through an agreement between the transaction service provider and the issuer institution. In some non-limiting embodiments or aspects, a transaction service provider may include a credit card company, a debit card company, and/or the like. As used herein, the term “transaction service provider system” may also refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

As used herein, the term “acquirer” may refer to an entity licensed by the transaction service provider and approved by the transaction service provider to originate transactions (e.g., payment transactions) using a portable financial device associated with the transaction service provider. As used herein, the term “acquirer system” may also refer to one or more computer systems, computer devices, and/or the like operated by or on behalf of an acquirer. The transactions may include payment transactions (e.g., purchases, original credit transactions (OCTs), account funding transactions (AFTs), and/or the like). In some non-limiting embodiments or aspects, the acquirer may be authorized by the transaction service provider to assign merchant or service providers to originate transactions using a portable financial device of the transaction service provider. The acquirer may contract with payment facilitators to enable the payment facilitators to sponsor merchants. The acquirer may monitor compliance of the payment facilitators in accordance with regulations of the transaction service provider. The acquirer may conduct due diligence of the payment facilitators and ensure that proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by an acquirer's payment facilitators, and/or the like. In some non-limiting embodiments or aspects, an acquirer may be a financial institution, such as a bank.

As used herein, the terms “electronic wallet,” “electronic wallet mobile application,” and “digital wallet” may refer to one or more electronic devices and/or one or more software applications configured to initiate and/or conduct transactions (e.g., payment transactions, electronic payment transactions, and/or the like). For example, an electronic wallet may include a user device (e.g., a mobile device) executing an application program and server-side software and/or databases for maintaining and providing transaction data to the user device. As used herein, the term “electronic wallet provider” may include an entity that provides and/or maintains an electronic wallet and/or an electronic wallet mobile application for a user (e.g., a customer). Examples of an electronic wallet provider include, but are not limited to, Google Pay®, Android Pay®, Apple Pay®, and Samsung Pay®. In some non-limiting examples, a financial institution (e.g., an issuer institution) may be an electronic wallet provider. As used herein, the term “electronic wallet provider system” may refer to one or more computer systems, computer devices, servers, groups of servers, and/or the like operated by or on behalf of an electronic wallet provider.

As used herein, the term “portable financial device” may refer to a payment device, an electronic payment device, a payment card (e.g., a credit or debit card), a gift card, a smartcard, smart media, a payroll card, a healthcare card, a wrist band, a machine-readable medium containing account information, a keychain device or fob, an RFID transponder, a retailer discount or loyalty card, a cellular phone, an electronic wallet mobile application, a personal digital assistant (PDA), a pager, a security card, a computer, an access card, a wireless terminal, a transponder, and/or the like. In some non-limiting embodiments or aspects, the portable financial device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like operated by or on behalf of a payment gateway and/or to a payment gateway itself. As used herein, the term “payment gateway mobile application” may refer to one or more electronic devices and/or one or more software applications configured to provide payment services for transactions (e.g., payment transactions, electronic payment transactions, and/or the like).

As used herein, the terms “client” and “client device” may refer to one or more client-side devices or systems (e.g., remote from a transaction service provider) used to initiate or facilitate a transaction (e.g., a payment transaction). As an example, a “client device” may refer to one or more point-of-sale devices used by a merchant, one or more acquirer host computers used by an acquirer, one or more mobile devices used by a user, and/or the like. In some non-limiting embodiments or aspects, a client device may be an electronic device configured to communicate with one or more networks and initiate or facilitate transactions. For example, a client device may include one or more computers, portable computers, laptop computers, tablet computers, mobile devices, cellular phones, wearable devices (e.g., watches, glasses, lenses, clothing, and/or the like), PDAs, and/or the like. Moreover, a “client” may also refer to an entity (e.g., a merchant, an acquirer, and/or the like) that owns, utilizes, and/or operates a client device for initiating transactions (e.g., for initiating transactions with a transaction service provider).

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

The term “processor,” as used herein, may represent any type of processing unit, such as a single processor having one or more cores, one or more cores of one or more processors, multiple processors each having one or more cores, and/or other arrangements and combinations of processing units.

Non-limiting embodiments or aspects of the disclosed subject matter are directed to systems, methods, and computer program products for training and/or fine-tuning deep learning models including, but not limited to, adversarial training and/or analyzing the impact of fine-tuning on deep learning models. For example, non-limiting embodiments or aspects of the disclosed subject matter provide iteratively generating a respective noise vector based on a radius hyperparameter for each sample of a dataset, iteratively adjusting the noise vector based on a step size hyperparameter (e.g., and a gradient of a particular loss function) and projecting the respective noise vector within a boundary based on the radius hyperparameter if the adjustment was beyond the boundary, and adjusting the parameters of a deep learning model based on the (adjusted and/or projected) noise vector and a gradient of the particular loss function. Such embodiments provide techniques and systems that provide improved adversarial training for a particular type of loss function and/or threat model (e.g., an [symbol] ₂ bounded noise vector) compared to other adversarial training techniques designed for other types of models with different loss functions and/or threat models (e.g., an [symbol] _{∞} bounded noise vector). Additionally, such embodiments provide techniques and systems that enable projecting the adjusted noise vector within the boundaries selected for the particular loss function and/or threat model (e.g., within the [symbol] ₂ ball of a given radius).

Additionally or alternatively, non-limiting embodiments or aspects of the disclosed subject matter provide fine-tuning first and second deep learning models (based on a pre-trained deep learning model), determining divergence for each of the first and second fine-tuned deep learning models from the pre-trained deep learning model, performing at least one parameter-free task with each model, performing at least one parametric task with each model, and determining intrinsic metrics for the first and second fine-tuned deep learning models in order to compare the first and second fine-tuned deep learning models. Such embodiments provide techniques and systems that enable analyzing of the first and second fine-tuned deep learning models, e.g., to understand whether and how fine-tuning such models for specific tasks using different fine-tuning techniques may have affected the performance of each model and/or degraded each model's ability to perform general tasks. Additionally, such embodiments provide techniques and systems that enable creating and demonstrating the efficacy of new training/fine-tuning techniques (e.g., new adversarial training techniques), e.g., for different deep learning models in different contexts and/or with different loss functions. Moreover, such embodiments provide techniques and systems that enable determining whether a deep learning model (or portions thereof, such as layers thereof) can be replaced with a compressed version of itself without degrading performance (e.g., based on the intrinsic metrics, such as singular value decomposition (SVD)-based analysis). Analyzing the impact of a deep learning model may include determining, analysing and/or assessing the performance of the deep learning model with regards to use of system resources. The performance of a deep learning model in conducting certain tasks can affect the allocation of computing resources and the efficiency with which those resources are used within a system configured to perform the task(s). Therefore, the improved performance or optimization of the deep learning models via fine-tuning, and the assessment and selection of a fine-tuned model for executing a specific task, can lead to system performance improvements such as processing speed gains, more efficient use of storage and more efficient use of system resources when conducting the task(s). By analyzing the performance of the first and second fine-tuned deep learning models, one or more computing components of the system can determine, for example, which model will be more efficient at performing a specific task, or which model, when principally performing the specific task, will have a minimal performance degradation when performing other general tasks. The system can then select the optimal deep learning model based on the computing resources available or the expected utilization of those resources. The system may take into account considerations relating to hardware.

For the purpose of illustration, in the following description, while the presently disclosed subject matter is described with respect to methods, systems, and computer program products for adversarial training and/or for analyzing the impact of fine-tuning on deep learning models, e.g., for a natural language processing (NLP) model such as a Bidirectional Encoder Representations from Transformers (BERT) model, one skilled in the art will recognize that the disclosed subject matter is not limited to the illustrative embodiments or aspects. For example, the methods, systems, and computer program products described herein may be used with a wide variety of settings, such as adversarial training and/or for analyzing the impact of fine-tuning in any setting suitable for using deep learning models, e.g., developing new or improved training algorithms (e.g., adversarial training algorithms) for a particular type of deep learning model (e.g., neural network (NN), recurrent neural network (RNN), and/or the like), evaluating performance of deep learning models after training (e.g., adversarial training) or fine-tuning in other contexts (e.g., transaction modeling, fraud detection, product recommendation, fault detection, speech recognition, device discovery and/or the like), and/or the like.

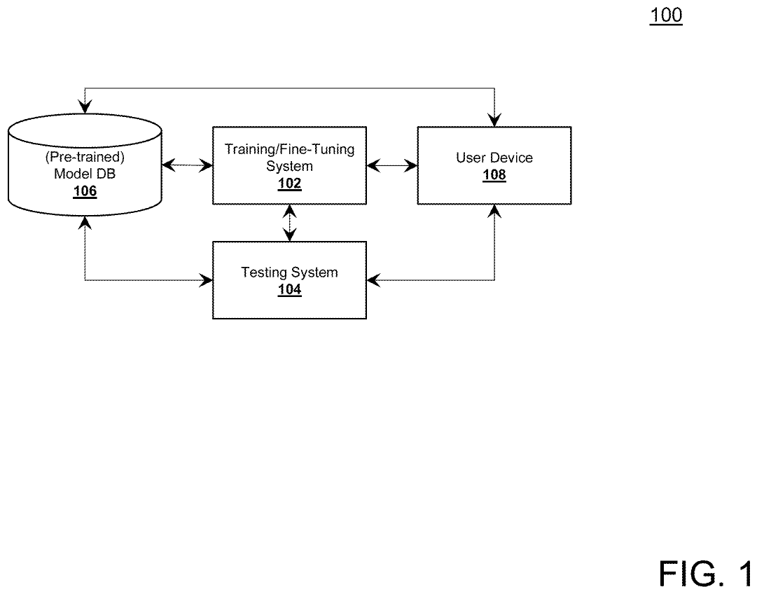

Referring now to FIG. 1, FIG. 1 is a diagram of an exemplary system 100 for adversarial training and/or for analyzing the impact of fine-tuning on deep learning models, according to some non-limiting embodiments or aspects of the presently disclosed subject matter. As shown in FIG. 1, environment 100 includes training/fine-tuning system 102, testing system 104, model database 106, and user device 108.

Training/fine-tuning system 102 may include one or more devices capable of receiving information from and/or communicating information to testing system 104, model database 106, and/or user device 108. For example, training/fine-tuning system 102 may include a computing device, such as a computer, a server, a group of servers, and/or other like devices. In some non-limiting embodiments or aspects, training/fine-tuning system 102 may include at least one graphics processing unit (GPU), at least one central processing unit (CPU), and/or the like having highly parallel structure and/or multiple cores to enable more efficient and/or faster performance of training and/or fine-tuning of one or more deep learning models.

Testing system 104 may include one or more devices capable of receiving information from and/or communicating information to training/fine-tuning system 102, model database 106, and/or user device 108. For example, testing system 104 may include a computing device, such as a computer, a server, a group of servers, and/or other like devices. In some non-limiting embodiments or aspects, testing system 104 may include at least one GPU, at least one CPU, and/or the like having highly parallel structure and/or multiple cores to enable more efficient and/or faster performance of testing of one or more deep learning models.

Model database 106 may include one or more devices capable of receiving information from and/or communicating information to training/fine-tuning system 102, testing system 104, and/or user device 108. For example, model database 106 may include a computing device, such as a computer, a server, a group of servers, and/or other like devices. In some non-limiting embodiments or aspects, model database 106 may be in communication with a data storage device, which may be local or remote to model database 106. In some non-limiting embodiments or aspects, model database 106 may be capable of receiving information from, storing information in, communicating information to, or searching information stored in the data storage device.

User device 108 may include one or more devices capable of receiving information from and/or communicating information to training/fine-tuning system 102, testing system 104, and/or model database 106. For example, user device 108 may include a computing device, such as a computer, a laptop computer, a tablet computer, a mobile device, a cellular phone, and/or the like.

The number and arrangement of systems and/or devices shown in FIG. 1 are provided as an example. There may be additional systems and/or devices; fewer systems and/or devices; different systems and/or devices; and/or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of system 100 may perform one or more functions described as being performed by another set of systems or another set of devices of system 100.

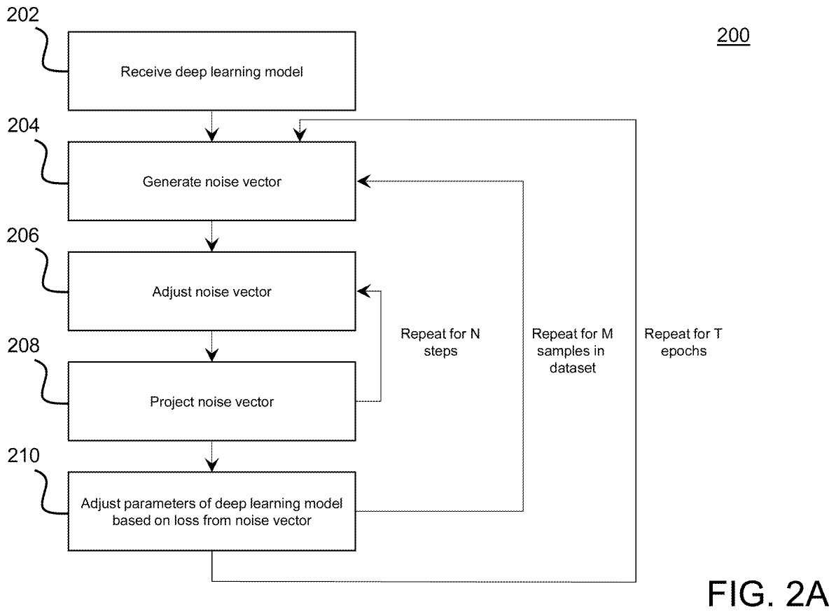

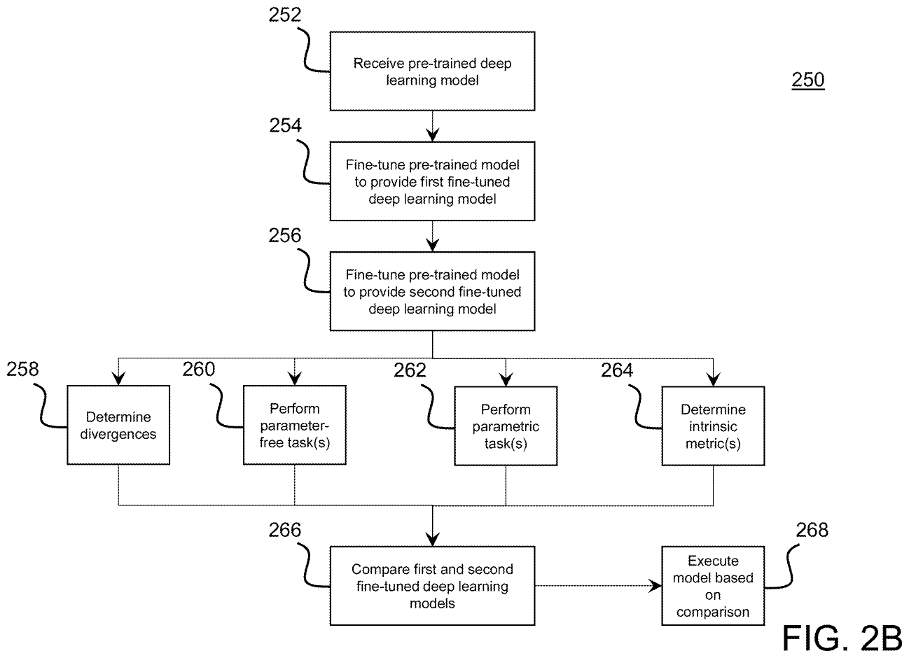

Referring now to FIG. 2A, FIG. 2A is a flowchart of an exemplary process 200 for adversarial training of deep learning models, according to some non-limiting embodiments or aspects of the presently disclosed subject matter. In some non-limiting embodiments or aspects, one or more of the steps of process 200 may be performed (e.g., completely, partially, and/or the like) by training/fine-tuning system 102 (e.g., one or more devices of training/fine-tuning system 102). In some non-limiting embodiments or aspects, one or more of the steps of process 200 may be performed (e.g., completely, partially, and/or the like) by another system, another device, another group of systems, or another group of devices, separate from or including training/fine-tuning system 102, such as testing system 104, model database 106, and user device 108.

As shown in FIG. 2A, at step 202, process 200 may include receiving a deep learning model. For example, training/fine-tuning system 102 may receive a deep learning model comprising a set of parameters (e.g., from model database 106).

In some non-limiting embodiments or aspects, training/fine-tuning system 102 also may receive a dataset comprising a plurality of samples. For example, training/fine-tuning system 102 also may receive (e.g., from model database 106) at least one dataset (e.g., a plurality of datasets), each comprising a plurality of samples.

In some non-limiting embodiments or aspects, the deep learning model (e.g., received by training/fine-tuning system 102) may include an NLP model. For example, the NLP model may include a BERT model. In some non-limiting embodiments or aspects, each dataset (e.g., received by training/fine-tuning system 102) may include a plurality of samples (e.g., sentences, paragraphs, documents, and/or the like). For example, the dataset may include at least one of the DBPedia ontology dataset (e.g., as described in Zhang et al., Character-level Convolutional Networks for Text Classification, Advances in neural information processing systems, 28:649-657 (2015)), the subjectivity analysis dataset (e.g., as described in Pang et al., A sentimental education: Sentiment analysis using subjectivity summarization based on minimum cuts, arXiv preprint cs/0409058 (2004)), the AG's News dataset (e.g., with four classes of news, wherein there are 30,000 samples per class, as described in Zhang et al., Character-level Convolutional Networks for Text Classification, Advances in neural information processing systems, 28:649-657 (2015)), the movie review dataset (e.g., as described in Pang et al., A sentimental education: Sentiment analysis using subjectivity summarization based on minimum cuts, arXiv preprint cs/0409058 (2004)), any combination thereof, and/or the like.

As shown in FIG. 2A, at step 204, process 200 may include generating a noise vector. For example, training/fine-tuning system 102 may generate a respective noise vector for a respective sample of the plurality of samples.

In some non-limiting embodiments or aspects, the respective noise vector may be randomly generated (e.g., by training/fine-tuning system 102). For example, the respective noise vector may be randomly generated (e.g., by training/fine-tuning system 102) based on a uniform distribution and a radius hyperparameter.

In some non-limiting embodiments or aspects, the respective noise vector may be generated (e.g., by training/fine-tuning system 102) based on a length of the respective sample and a radius hyperparameter. For example, the respective noise vector may be generated based on the following equation:

$$δ = \frac{1}{\sqrt{{L}_{i}}} U ( - ϵ , ϵ )$$

wherein δ is the noise vector, Lᵢ is the length of the respective sample, ϵ is the radius hyperparameter, and U(−ϵ, ϵ) is a uniform distribution from −ϵ to ϵ.

As shown in FIG. 2A, at step 206, process 200 may include adjusting a noise vector. For example, training/fine-tuning system 102 may adjust the respective noise vector based on a step size hyperparameter.

In some non-limiting embodiments or aspects, the respective noise vector may be adjusted (e.g., by training/fine-tuning system 102) based on the (current) noise vector, a step size hyperparameter, a loss function, a deep learning model (e.g., ƒ_{θ}) with (current) parameters (e.g., θ), the respective sample, an expected output of the deep learning model, any combination thereof, and/or the like.

In some non-limiting embodiments or aspects, the noise vector may be adjusted based on the following equation:

$$δ = δ + α \cdot \frac{{∇}_{δ} ℓ ( {f}_{θ} ( {x}_{i} + δ ) , {y}_{i} )}{‖ {∇}_{δ} ℓ ( {f}_{θ} ( {x}_{i} + δ ) , {y}_{i} ) ‖}$$

wherein δ is the noise vector, α is the step size hyperparameter, [symbol] ( ) is a loss function, ƒ_{θ}( ) is an output of the deep learning model, ∇_{δ} is the gradient of δ, xᵢ is the respective sample, and yᵢ is an expected output of the deep learning model.

As shown in FIG. 2A, at step 208, process 200 may include projecting a noise vector. For example, training/fine-tuning system 102 may project the respective noise vector to be within a boundary based on the radius hyperparameter if the respective noise vector was adjusted beyond the boundary after adjusting the respective noise vector.

In some non-limiting embodiments or aspects, the respective noise vector may be projected based on the following equation:

$$δ = \frac{δ}{max ( 1 , \frac{‖ δ ‖}{ϵ} )}$$

wherein δ is the noise vector and ϵ is the radius hyperparameter.

In some non-limiting embodiments, steps 206 and 208 may be repeated for a target number (N) of steps.

As shown in FIG. 2A, at step 210, process 200 may include adjusting parameters of a deep learning model based on a loss resulting from the noise vector. For example, training/fine-tuning system 102 may adjust the set of parameters of the deep learning model based on a gradient of a loss, which may be calculated based on the respective noise vector.

In some non-limiting embodiments or aspects, the parameters may be adjusted (e.g., by training/fine-tuning system 102) based on the (current) parameters, a loss function, a deep learning model (e.g., ƒ_{θ}) with the (current) parameters, the respective sample, an expected output of the deep learning model, any combination thereof, and/or the like.

In some non-limiting embodiments or aspects, the set of parameters may be adjusted based on the following equation:

$$θ = θ - {∇}_{θ} ℓ ( {f}_{θ} ( {x}_{i} + δ ) , {y}_{i} )$$

wherein δ is the noise vector, θ is the set of parameters, [symbol] ( ) is a loss function, ƒ_{θ}( ) is an output of the deep learning model, and yᵢ is an expected output of the deep learning model.

In some non-limiting embodiments or aspects, steps 204 through 210 (including the internal repetition of steps 206 and 208 for N steps) may be repeated for each sample of the plurality of samples (e.g., M samples) of the dataset. Additionally or alternatively, steps 204 through 210 (including the internal repetition of steps 206 and 208 for N steps and the internal repetition of steps 204 through 210 for M samples) may be repeated for a target number (T) of epochs.

In some non-limiting embodiments or aspects, process 200 may be represented by the following algorithm:

Algorithm 1

```
for t = 1 ... T do
  for i = 1 ... M do
    $δ = \frac{1}{\sqrt{{L}_{i}}} Uniform ( - ϵ , ϵ )$
    for j = 1 ... N do
      $δ = δ + α \cdot \frac{{∇}_{δ} ℓ ( {f}_{θ} ( {x}_{i} + δ ) , {y}_{i} )}{‖ {∇}_{δ} ℓ ( {f}_{θ} ( {x}_{i} + δ ) , {y}_{i} ) ‖}$
      $δ = \frac{δ}{max ( 1 , \frac{\vert \vert δ \vert \vert}{ϵ} )}$
    end for
    θ = θ − ∇_{θ} [symbol] (f_{θ}(xᵢ + δ), yᵢ)
  end for
end for
```

Referring now to FIG. 2B, FIG. 2B is a flowchart of an exemplary process 250 for analyzing the impact of fine-tuning on deep learning models, according to some non-limiting embodiments or aspects of the presently disclosed subject matter. In some non-limiting embodiments or aspects, one or more of the steps of process 250 may be performed (e.g., completely, partially, and/or the like) by training/fine-tuning system 102 (e.g., one or more devices of training/fine-tuning system 102). In some non-limiting embodiments or aspects, one or more of the steps of process 250 may be performed (e.g., completely, partially, and/or the like) by another system, another device, another group of systems, or another group of devices, separate from or including training/fine-tuning system 102, such as testing system 104, model database 106, and user device 108.

As shown in FIG. 2B, at step 252, process 250 may include receiving a pre-trained deep learning model. For example, training/fine-tuning system 102 may receive a pre-trained deep learning model comprising a first set of parameters (e.g., from model database 106).

In some non-limiting embodiments or aspects, the deep learning model may include an NLP model. For example, the NLP model may include a BERT model.

As shown in FIG. 2B, at step 254, process 250 may include fine-tuning the pre-trained model to provide a first fine-tuned deep learning model. For example, training/fine-tuning system 102 may copy the pre-trained model and/or parameters thereof (e.g., the first set of parameters) to provide a first copy of the deep learning model. Additionally or alternatively, training/fine-tuning system 102 may fine-tune (the first copy of) the deep learning model to perform a target task based on a first fine-tuning technique to provide a first fine-tuned deep learning model.

In some non-limiting embodiments or aspects, the first fine-tuning technique may include a fine-tuning technique without adversarial training. For example, fine-tuning the pre-trained model may include training/fine-tuning system 102 fine-tuning the first copy of the deep learning model to perform the target task based on the fine-tuning technique without adversarial training to provide the first fine-tuned deep learning model.

As shown in FIG. 2B, at step 256, process 250 may include fine-tuning the pre-trained model to provide a second fine-tuned deep learning model. For example, training/fine-tuning system 102 may copy the pre-trained model and/or parameters thereof (e.g., the first set of parameters) to provide a second copy of the deep learning model. Additionally or alternatively, training/fine-tuning system 102 may fine-tune (the second copy of) the deep learning model to perform the target task based on a second fine-tuning technique to provide a second fine-tuned deep learning model. For example, the second fine-tuning technique may be different than the first fine-tuning technique.

In some non-limiting embodiments or aspects, the second fine-tuning technique may include at least one fine-tuning technique with adversarial training, as described herein. For example, the second fine-tuning technique may be performed according to the technique described with respect to FIG. 2A (e.g., process 200). For example, fine-tuning the pre-trained model may include training/fine-tuning system 102 fine-tuning the second (and/or third, etc.) copy (and/or copies) of the deep learning model to perform the target task based on the fine-tuning technique with adversarial training to provide the second (and/or third, etc.) fine-tuned deep learning model(s).

As shown in FIG. 2B, at step 258, process 250 may include determining the divergences of the first and second fine-tuned deep learning models from the pre-trained deep learning model (and/or other proxy metrics). For example, testing system 104 may determine a first divergence of the first fine-tuned deep learning model from the pre-trained deep learning model. Additionally or alternatively, testing system 104 may determine a second divergence of the second fine-tuned deep learning model from the pre-trained deep learning model.

In some non-limiting embodiments or aspects, determining the first divergence may include determining a first symmetrized Kullback-Leibler (KL) divergence based on the first fine-tuned deep learning model and the pre-trained deep learning model. Additionally or alternatively, determining the second divergence may include determining a second symmetrized KL divergence based on the second fine-tuned deep learning model and the pre-trained deep learning model.

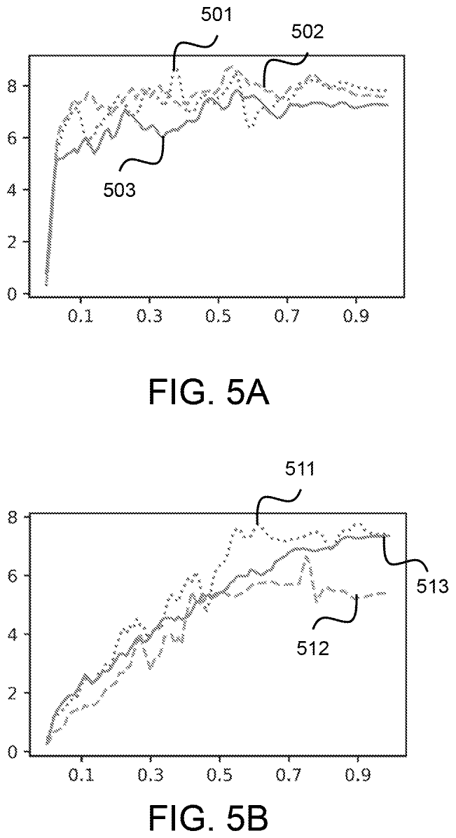

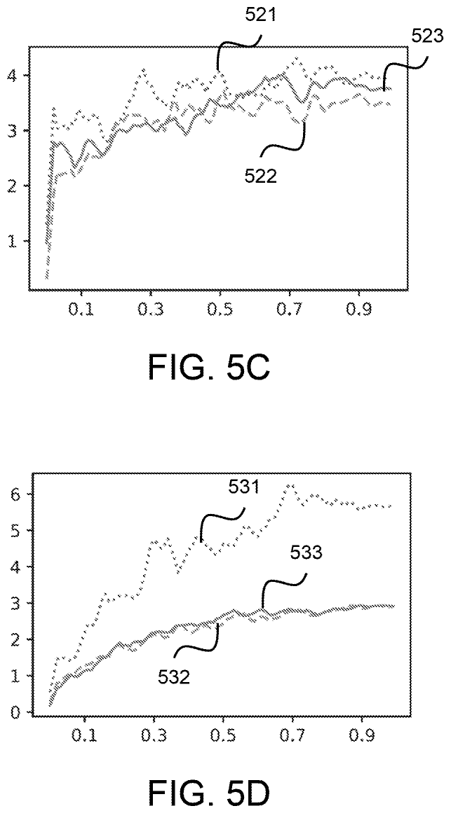

Referring now to FIGS. 5A-5D, FIGS. 5A-5D are graphs showing performance of exemplary implementations of process 200 for adversarial training of deep learning models, according to some non-limiting embodiments or aspects of the presently disclosed subject matter. As shown in FIGS. 5A-5D, the vertical axis may represent KL distance (e.g., the sum of the KL divergences in both directions) between a pre-trained deep learning model (e.g., BERT model) and respective fine-tuned models, and the horizontal axis may represent a portion of training steps completed.

As shown in FIG. 5A, a first curve 501 may represent a fine-tuned model without adversarial training, a second curve 502 may represent a fine-tuned model with a single step (e.g., N=1) of adversarial training, and a third curve 503 may represent a fine-tuned model with 20 steps (e.g., N=20) of adversarial training. The dataset used for the graph in FIG. 5A may be the DBpedia ontology dataset, as described herein.

As shown in FIG. 5B, a first curve 511 may represent a fine-tuned model without adversarial training, a second curve 512 may represent a fine-tuned model with a single step (e.g., N=1) of adversarial training, and a third curve 513 may represent a fine-tuned model with 20 steps (e.g., N=20) of adversarial training. The dataset used for the graph in FIG. 5B may be the subjectivity analysis dataset, as described herein.

As shown in FIG. 5C, a first curve 521 may represent a fine-tuned model without adversarial training, a second curve 522 may represent a fine-tuned model with a single step (e.g., N=1) of adversarial training, and a third curve 523 may represent a fine-tuned model with 20 steps (e.g., N=20) of adversarial training. The dataset used for the graph in FIG. 5C may be the AG's News dataset, as described herein.

As shown in FIG. 5D, a first curve 531 may represent a fine-tuned model without adversarial training, a second curve 532 may represent a fine-tuned model with a single step (e.g., N=1) of adversarial training, and a third curve 533 may represent a fine-tuned model with 20 steps (e.g., N=20) of adversarial training. The dataset used for the graph in FIG. 5D may be the movie review dataset, as described herein.

As shown in FIGS. 5A-5D, the models with adversarial training diverge less from the pre-trained model. As such, performance of the models may be improved based on adversarial training, as described herein.

Table 1 summarizes accuracy of a fine-tuned model without adversarial training (“van”), a fine-tuned model with a single step (e.g., N=1) of adversarial training (“adv-1”), and a fine-tuned model with 20 steps (e.g., N=20) of adversarial training (“adv-20”) for the original (e.g., ordered) datasets (e.g., the DBpedia ontology dataset (DBpedia), the subjectivity analysis dataset (SUBJ), the AG's News dataset (AGNews), and the movie review dataset (MR), as described herein) and the average accuracy of ten corresponding sets of randomly ordered words for each example in the set.

TABLE 1

| | Original | | | Random Subset | | |
|---|---|---|---|---|---|---|
| Dataset | van | adv-1 | adv-20 | van | adv-1 | adv-20 |
| DBpedia | 99.37 | 99.30 | 99.33 | 94.57 | 94.43 | 93.95 |
| SUBJ | 96.76 | 97.10 | 96.47 | 81.21 | 77.70 | 72.62 |
| AGNews | 94.34 | 94.05 | 93.72 | 90.24 | 89.43 | 88.89 |
| MR | 87.05 | 86.71 | 86.94 | 71.25 | 71.90 | 68.55 |

As shown in Table 1, the performance of the fine-tuned model without adversarial training (“van”) and the performance of the fine-tuned models with a single step (“adv-1”) and 20 steps (“adv-20”) of adversarial training are similar on the original, ordered datasets, and the performance of all models degrade for the randomly-ordered subsets. On all of the randomly-ordered subsets, the performance of the fine-tuned model with 20 steps of adversarial training (“adv-20”) is the lowest, with the drops being most significant on the SUBJ dataset (e.g., 16% for the “van” model and 25% for the “adv-20” model). This may suggest that adversarial training actually improved preservation of (general) syntactic abilities after fine-tuning (e.g., for a specific task). As such, in some non-limiting embodiments or aspects, accuracy as described above may be used as a proxy metric in addition to and/or in lieu of determining KL divergence and/or KL distance.

As shown in FIG. 2B, at step 260, process 250 may include performing at least one parameter-free task with each of the models. For example, testing system 104 may perform at least one parameter-free task with each of the pre-trained deep learning model, the first fine-tuned deep learning model, and the second fine-tuned deep learning model.

In some non-limiting embodiments or aspects, if the deep learning models are NLP (e.g., BERT) models, performing the parameter-free task(s) may include performing at least one of a syntactic task and/or a morphological task based on masking a word of at least one input sample with each of the pre-trained deep learning model, the first fine-tuned deep learning model, and the second fine-tuned deep learning model. For example, given two sample sentences where one has a correct word (e.g., “A teacher wasn't insulted by Julie”) and one has an incorrect word (e.g., “A teacher wasn't died by Julie”), masking a word may include inputting a sentence with the focus word masked (e.g., “A teacher wasn't MASK by Julie”) to the deep learning model and comparing the score assigned to the correct word (e.g., “insulted”) with the score assigned to the incorrect one (e.g., “died”).

Table 2 summarizes performance (e.g., accuracy) of a pre-trained model (“base”), a fine-tuned model without adversarial training (“van”), and a fine-tuned model with adversarial training (“adv”) (e.g., 20 steps adversarial training) for various syntactic or morphological tasks based on the datasets (e.g., the DBpedia ontology dataset (DBpedia), the subjectivity analysis dataset (SUBJ), the AG's News dataset (AGNews), and the movie review dataset (MR), as described herein).

TABLE 2

| | | DBpedia | | SUBJ | | AGNews | | MR | | |
|---|---|---|---|---|---|---|---|---|---|---|
| Task | base | van | adv | van | adv | van | adv | van | adv | #pairs |
| Subject | 90.98 | 88.70 | 89.40 | 90.70 | 90.14 | 90.55 | 91.66 | 78.22 | 88.27 | 121,220 |
| Verb | | | | | | | | | | |
| Agreement | | | | | | | | | | |
| Anaphora | 95.26 | 95.06 | 93.54 | 73.66 | 89.38 | 65.00 | 90.68 | 69.48 | 89.97 | 26,040 |
| Agreement | | | | | | | | | | |
| Subject | 90.88 | 90.38 | 91.71 | 88.93 | 91.75 | 90.16 | 91.28 | 87.68 | 90.85 | 3,739 |
| Verb | | | | | | | | | | |
| Agreement | | | | | | | | | | |
| Determiner | 98.35 | 98.16 | 97.46 | 96.01 | 97.01 | 96.84 | 97.91 | 92.81 | 97.55 | 6,926 |
| Noun | | | | | | | | | | |
| Agreement | | | | | | | | | | |
| Anaphora | 97.15 | 98.22 | 98.31 | 88.90 | 96.10 | 95.02 | 98.08 | 89.90 | 95.50 | 2,000 |
| Agreement | | | | | | | | | | |
| Argument | 81.61 | 77.60 | 77.57 | 77.99 | 79.00 | 77.89 | 79.09 | 74.39 | 75.74 | 3,056 |
| Structure | | | | | | | | | | |
| Irregular | 97.20 | 95.00 | 95.06 | 93.76 | 95.88 | 95.51 | 97.33 | 85.23 | 95.15 | 1,963 |
| Forms | | | | | | | | | | |
| Island | 76.40 | 77.36 | 75.07 | 84.40 | 84.01 | 78.79 | 85.59 | 75.96 | 81.63 | 1,000 |
| Effects | | | | | | | | | | |

As shown in Table 2, the fine-tuned model with adversarial training (“adv”) performs better than the fine-tuned model without adversarial training (“van”) in most of the tasks for most of the datasets. For example, the improvement of the fine-tuned model with adversarial training (“adv”) over the fine-tuned model without adversarial training (“van”) is about 21% for anaphora agreement when the models are fine-tuned on the SUBJ dataset, and the improvement is 38% for the AGNews dataset. As an additional example, the improvement of the fine-tuned model with adversarial training (“adv”) over the fine-tuned model without adversarial training (“van”) is about 12% for irregular form for the MR dataset. Generally, the fine-tuned model with adversarial training (“adv”) remains more faithful to the pre-trained (“base”) model, which helps maintain the (general) syntactic abilities of the pre-trained model.

As shown in FIG. 2B, at step 262, process 250 may include performing at least one parametric task with each of the models. For example, testing system 104 may perform at least one parametric task with each of the pre-trained deep learning model, the first fine-tuned deep learning model, and the second fine-tuned deep learning model. In some non-limiting embodiments or aspects, the parametric task(s) may include at least one linear probe. For example, testing system 104 may extract at least one embedding (e.g., at least one embedding vector, which may be based on activations of the node(s) of the layer, and/or the like) from a selected layer (e.g., a last layer, a hidden layer, and/or the like) of each model and train a linear model to perform a task based on the embedding(s).

In some non-limiting embodiments or aspects, if the deep learning models are NLP (e.g., BERT) models, performing the parametric task(s) may include performing at least one of part of speech (POS) tagging, dependency arc labeling, or dependency parsing with each of the pre-trained deep learning model, the first fine-tuned deep learning model, and the second fine-tuned deep learning model.

Table 3 summarizes performance (e.g., accuracy) of a pre-trained model (“base”), a fine-tuned model without adversarial training (“van”), and a fine-tuned model with adversarial training (“adv”) (e.g., 20 steps adversarial training) for various parametric tasks based on the datasets (e.g., the DBpedia ontology dataset (DBpedia), the subjectivity analysis dataset (SUBJ), the AG's News dataset (AGNews), and the movie review dataset (MR), as described herein).

TABLE 3

| | | DBpedia | | SUBJ | | AGNews | | MR | |
|---|---|---|---|---|---|---|---|---|---|
| Task | base | van | adv | van | adv | van | adv | van | adv |
| POS | 94.70 | 93.62 | 93.90 | 92.67 | 93.33 | 91.74 | 93.07 | 90.86 | 93.31 |
| tagging | | | | | | | | | |
| Dependency | 92.07 | 90.54 | 91.17 | 89.72 | 90.57 | 88.22 | 89.78 | 87.53 | 90.32 |
| labeling | | | | | | | | | |
| Dependency | 79.29 | 74.85 | 76.39 | 72.73 | 74.78 | 69.74 | 73.97 | 66.59 | 74.19 |
| parsing | | | | | | | | | |

As shown in Table 3, the fine-tuned model with adversarial training (“adv”) performs better than the fine-tuned model without adversarial training (“van”) for all of the pairwise comparisons.

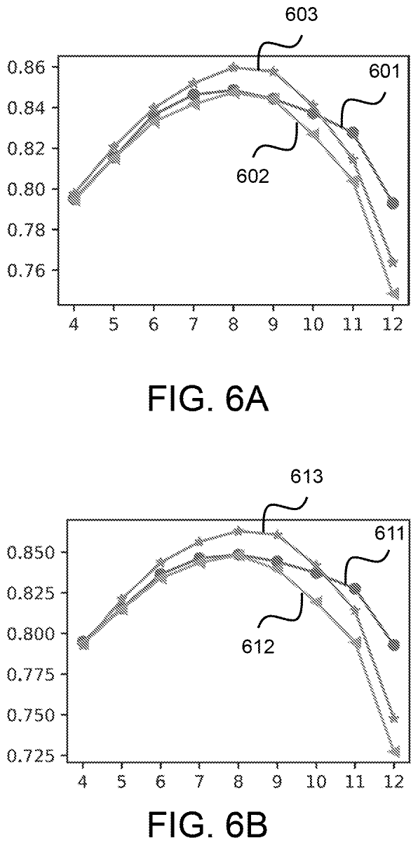

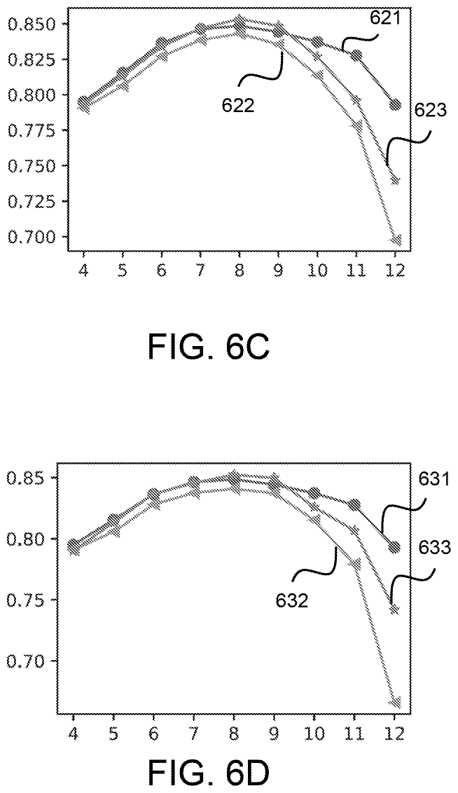

Referring now to FIGS. 6A-6D, FIGS. 6A-6D are graphs showing performance of exemplary implementations of the techniques described herein, according to some non-limiting embodiments or aspects of the presently disclosed subject matter. As shown in FIGS. 6A-6D, the vertical axis may represent unlabeled attachment score (UAS), and the horizontal axis may represent the layer of the respective model.

As shown in FIG. 6A, a first curve 601 may represent a pre-trained model (“base”), a second curve 602 may represent a fine-tuned model without adversarial training (“van”), and a third curve 603 may represent a fine-tuned model with adversarial training (“adv”) (e.g., 20 steps adversarial training). The dataset used for the graph in FIG. 6A may be the DBpedia ontology dataset, as described herein.

As shown in FIG. 6B, a first curve 611 may represent a pre-trained model (“base”), a second curve 612 may represent a fine-tuned model without adversarial training (“van”), and a third curve 613 may represent a fine-tuned model with adversarial training (“adv”) (e.g., 20 steps adversarial training). The dataset used for the graph in FIG. 6B may be the subjectivity analysis dataset, as described herein.

As shown in FIG. 6C, a first curve 621 may represent a pre-trained model (“base”), a second curve 622 may represent a fine-tuned model without adversarial training (“van”), and a third curve 623 may represent a fine-tuned model with adversarial training (“adv”) (e.g., 20 steps adversarial training). The dataset used for the graph in FIG. 6C may be the AG's News dataset, as described herein.

As shown in FIG. 6D, a first curve 631 may represent a pre-trained model (“base”), a second curve 632 may represent a fine-tuned model without adversarial training (“van”), and a third curve 633 may represent a fine-tuned model with adversarial training (“adv”) (e.g., 20 steps adversarial training). The dataset used for the graph in FIG. 6D may be the movie review dataset, as described herein.

As shown in FIGS. 6A-6D, for all models (e.g., base, van, and adv trained on all datasets), the best UAS score is achieved at the eighth layer. For example, fine-tuned model with adversarial training (“adv”) for the DBpedia dataset achieves a UAS score of 86.30, surpassing the pre-trained model (“base”) by 1.4 percentage points. In some non-limiting embodiments or aspects, after that layer, the performance may degrade for all models. For example, the sharpest drops may be at the last two layers. As shown in FIGS. 6A-6D, the fine-tuned models with adversarial training (“adv”) for all data sets have more than 1.0 percentage points higher UAS than the fine-tuned models without adversarial training (“van”) at the eighth layer, and the difference in UAS increases to 4.2 and 7.6 percentage points at that last layer for the AGNews and MR datasets, respectively. Additionally, the fine-tuned models with adversarial training (“adv”) demonstrate improvements over the pre-trained model (e.g., “base”) in the middle layers. Drops at the last layers for fine-tuned models may be attributed to later layers of the models being more specialized for the specific task for which the models were fine-tuned.

As shown in FIG. 2B, at step 264, process 250 may include determining at least one intrinsic metric for each of the fine-tuned models. For example, testing system 104 may determine at least one intrinsic metric for each of the first fine-tuned deep learning model and the second fine-tuned deep learning model.

In some non-limiting embodiments or aspects, determining the at least one intrinsic metric may include determining at least one of a first metric based on gradient-based analysis or a second metric based on singular value decomposition (SVD)-based analysis for each of the first fine-tuned deep learning model and the second fine-tuned deep learning model.

In some non-limiting embodiments or aspects, a (first) metric based on gradient-based analysis may be based on how inputs (e.g., words of samples) influence each other. For example, such a metric may estimate the influence of a first word on the representation of a second word at a selected layer. In some non-limiting embodiments or aspects, the (first metric based on gradient-based analysis may be represented by the following equation:

$${S}_{ij}^{l} = ‖ \frac{\partial ‖ {h}_{i}^{l} ‖}{\partial {x}_{j}} ‖$$

where Sᵢⱼ^{l} may be the metric estimating the influence of the jth word on the representation of the ith word at the Ith layer, xⱼ is the jth word, and hᵢ^{l} is the ith word at the Ith layer.

In some non-limiting embodiments or aspects, the (first) metric may be used to create a dependency graph. For example, the S scores (e.g., based on the equation above) may be used to create a dependency graph (e.g., a directed influence map and/or the like). For the purpose of illustration and not limitation, the negative value of the S scores may be used to determine a spanning arborescence of minimum weight. Additionally or alternatively, a directed graph analogue of a minimum spanning tree algorithm may be used to find heads and dependents. For example, the word j with the highest ΣᵢSᵢⱼ^{l} as the root, and the directed graph analogue of the minimum spanning tree algorithm may be used to find the heads and dependents, which may determine (and/or be used to determine) the most influential words in a sentence (e.g., sample).

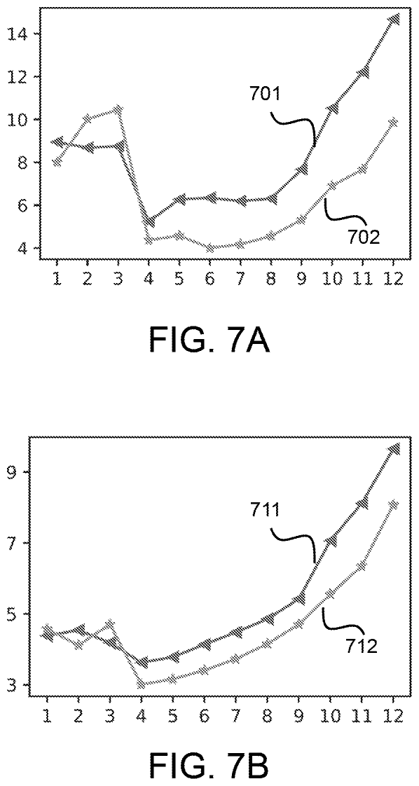

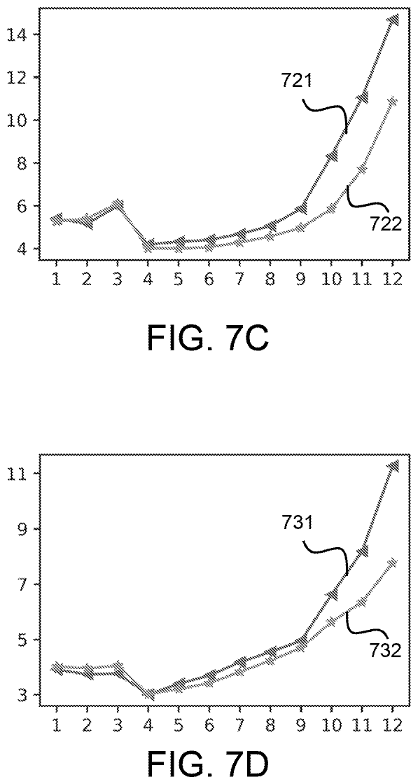

Referring now to FIGS. 7A-7D, FIGS. 7A-7D are graphs showing performance of exemplary implementations of the techniques described herein, according to some non-limiting embodiments or aspects of the presently disclosed subject matter. As shown in FIGS. 7A-7D, the vertical axis may represent average maximum degree of a respective directed influence map, and the horizontal axis may represent the layer of the respective model.

As shown in FIG. 7A, a first curve 701 may represent a fine-tuned model without adversarial training (“van”), and a second curve 702 may represent a fine-tuned model with adversarial training (“adv”) (e.g., 20 steps adversarial training). The dataset used for the graph in FIG. 7A may be the DBpedia ontology dataset, as described herein.

As shown in FIG. 7B, a first curve 711 may represent a fine-tuned model without adversarial training (“van”), and a second curve 712 may represent a fine-tuned model with adversarial training (“adv”) (e.g., 20 steps adversarial training). The dataset used for the graph in FIG. 7B may be the subjectivity analysis dataset, as described herein.

As shown in FIG. 7C, a first curve 721 may represent a fine-tuned model without adversarial training (“van”), and a second curve 722 may represent a fine-tuned model with adversarial training (“adv”) (e.g., 20 steps adversarial training). The dataset used for the graph in FIG. 7C may be the AG's News dataset, as described herein.

As shown in FIG. 7D, a first curve 731 may represent a fine-tuned model without adversarial training (“van”), and a second curve 732 may represent a fine-tuned model with adversarial training (“adv”) (e.g., 20 steps adversarial training). The dataset used for the graph in FIG. 7D may be the movie review dataset, as described herein.

As shown in FIGS. 7A-7D, the fine-tuned models with adversarial training (“adv”) maintains lower maximum degrees than the fine-tuned models without adversarial training (“van”), which shows the moderating effect of adversarial training on the influence one word could have on the whole sentence. Additionally, the difference between these two types of models increases in later (e.g., higher) layers. As such, the fine-tuned models without adversarial training (“van”) tend to overestimate the importance of individual words leading to less representational diversity, and large maximum degrees decrease such a model's sensitivity to hierarchies, leading to the collapse of syntactic structures. In contrast, the fine-tuned models with adversarial training (“adv”) have a lesser tendency to overestimate importance, and smaller maximum degrees show improved sensitivity to hierarchies and preservation of syntactic structure.

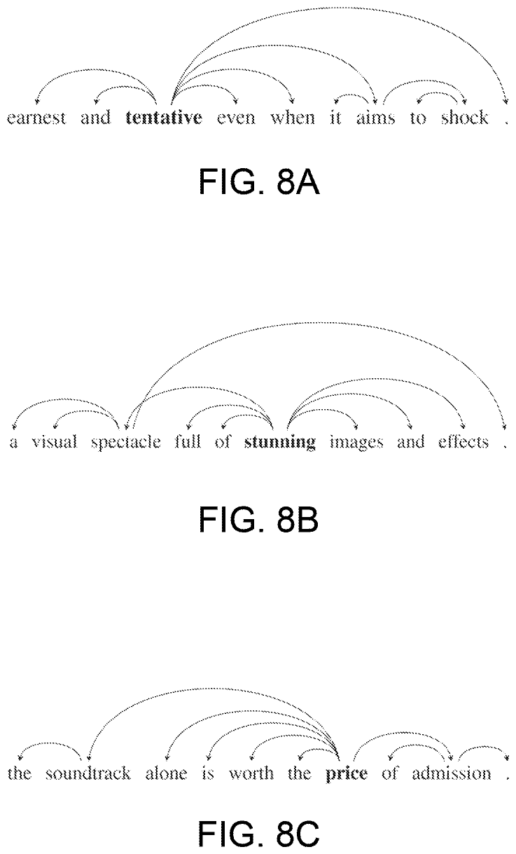

Referring now to FIGS. 8A-8C, FIGS. 8A-8C are diagrams of exemplary dependency graphs (e.g., dependency arc labeling) based on exemplary implementations of the techniques described herein, according to some non-limiting embodiments or aspects of the presently disclosed subject matter. For the purpose of illustration and not limitation, the depicted dependency graphs (e.g., dependency arc labeling) may be based on (e.g., extracted from) the last layer's representations for the movie review (MR) dataset of an exemplary fine-tuned model with adversarial training (“adv”), as described herein.

As shown in FIG. 8A, the word “tentative” is the root. The root is directly connected to some words (e.g., “earnest”, “and”, “even”, “when”, “aims”, and “.”), and is indirectly connected to other words (e.g., two hops to “it” and “shock”, and three hops to “to”).

As shown in FIG. 8B, the word “stunning” is the root. The root is directly connected to some words, and is indirectly connected to other words (e.g., two or three hops).

As shown in FIG. 8C, the word “price” is the root. The root is directly connected to some words, and is indirectly connected to other words (e.g., two or three hops).

As shown in FIGS. 8A-8C, the depth of the tree in all of these examples is two and there exist nodes other than the roots with dependents (e.g., two or three hops from the root to some words that are dependent upon words other than the root). In contrast, a fine-tuned model without adversarial training (“van”) would have the root directly connected to all other nodes (e.g., a flat structure with only one head in the sentence).

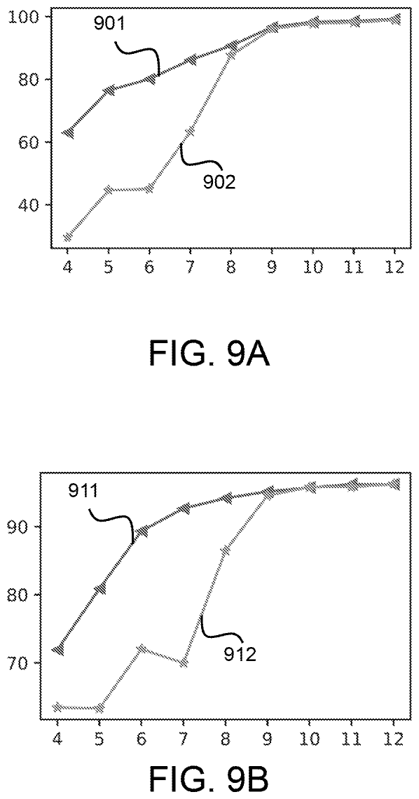

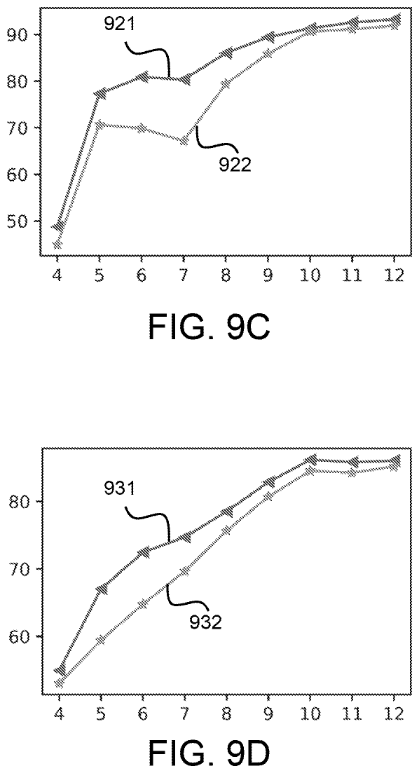

In some non-limiting embodiments or aspects, a (second) metric based on SVD-based analysis may quantify diversity in word representations. For example, as one or few words become more dominant and affect other words, a matrix representing a sentence may tend towards a more low-rank matrix. For the purpose of illustration and not limitation, even though the actual rank of the matrix may not change, a low-rank approximation of the matrix may be used to perform for the downstream tasks. For example, a rank-1 approximation of the representations (e.g., embeddings, word representations, and/or the like) may be used, and/or Ith hidden layer h^{l} may be replaced with U₁σV₁^{t}, wherein U₁, σ, and V₁^{t} are the first left singular vector, the largest singular value, and the right singular vector, respectively, associated with the SVD decomposition of h^{l}. Additionally or alternatively, the low-rank approximation of the Ith hidden layer h^{l} may be passed to the next layer of the model (e.g., keeping everything else about the model/other layers intact), and accuracy may then be measured. The accuracy may be plotted, for example, as further described below with reference to FIG. 9. For example, accuracy at the ith layer may be plotted based on the following equation:

$${L}_{n} ( … {L}_{i + 1} ( {SVD}_{1} ( {L}_{i} ( … {L}_{1} ( x ) ) ) ) )$$

where Lᵢ is the ith layer of the model (e.g., BERT model), SVD₁ is the rank-1 approximation.

Referring now to FIGS. 9A-9D, FIGS. 9A-9D are graphs showing performance of exemplary implementations of the techniques described herein, according to some non-limiting embodiments or aspects of the presently disclosed subject matter. As shown in FIGS. 9A-9D, the vertical axis may represent accuracy, and the horizontal axis may represent the layer of the respective model that is replaced with a low-rank approximation.

As shown in FIG. 9A, a first curve 901 may represent a fine-tuned model without adversarial training (“van”), and a second curve 902 may represent a fine-tuned model with adversarial training (“adv”) (e.g., 20 steps adversarial training). The dataset used for the graph in FIG. 9A may be the DBpedia ontology dataset, as described herein.

As shown in FIG. 9B, a first curve 911 may represent a fine-tuned model without adversarial training (“van”), and a second curve 912 may represent a fine-tuned model with adversarial training (“adv”) (e.g., 20 steps adversarial training). The dataset used for the graph in FIG. 9B may be the subjectivity analysis dataset, as described herein.

As shown in FIG. 9C, a first curve 921 may represent a fine-tuned model without adversarial training (“van”), and a second curve 922 may represent a fine-tuned model with adversarial training (“adv”) (e.g., 20 steps adversarial training). The dataset used for the graph in FIG. 9C may be the AG's News dataset, as described herein.

As shown in FIG. 9D, a first curve 931 may represent a fine-tuned model without adversarial training (“van”), and a second curve 932 may represent a fine-tuned model with adversarial training (“adv”) (e.g., 20 steps adversarial training). The dataset used for the graph in FIG. 9D may be the movie review dataset, as described herein.

As shown in FIGS. 9A-9D, the fine-tuned models with adversarial training (“adv”) tend to have lower accuracy (e.g., are more sensitive to the approximation), especially when lower layers are replaced with low-rank approximations, and this decrease in accuracy suggests the fine-tuned model with adversarial training (“adv”) encodes more information than the fine-tuned models without adversarial training (“van”). Additionally, even in fine-tuned models with adversarial training (“adv”) with the last few layers replaced with rank-1 approximations, accuracy increases, and this increase suggests such models achieve high accuracy.

As shown in FIG. 2B, at step 266, process 250 may include comparing the fine-tuned models. For example, testing system 104 and/or user device 108 may compare the first fine-tuned deep learning model and the second fine-tuned deep learning model based on at least one of determining of the first divergence and the second divergence (step 258), performing the at least one parameter-free task (step 260), performing the at least one parametric task (step 262), determining the at least one intrinsic metric (step 264), any combination thereof, and/or the like. In some non-limiting embodiments or aspects, comparing the first fine-tuned deep learning model and the second fine-tuned deep learning model may include at least one of displaying (e.g., by user device 108) at least one first graph based on determining of the first divergence and the second divergence, displaying (e.g., by user device 108) at least one first table based on performing the at least one parameter-free task, displaying (e.g., by user device 108) at least one second table and/or at least one second graph based on performing the at least one parametric task, displaying (e.g., by user device 108) at least one third graph based on determining the at least one intrinsic metric, any combination thereof, and/or the like. For example, in some non-limiting embodiments or aspects, such graphs and/or tables may be the same as or similar to the graphs and tables described above.

The comparison may be performed by one or more processors of the testing system 104 and/or the user device 108. Based on the comparison, a processor of a component of the system 100, for example a processor of the testing system 104 and/or the user device 108, may select a deep learning model with which to perform the target task, or with which to perform specific tasks. For example, the processor may determine, based on the comparison, that the second fine-tuned deep learning model provides a more accurate result when performing a target task than the first fine-tuned deep learning model. In this case, one or more processors of the system 100, such as the processor of the testing system 104 and/or the user device 108, is able to select, initiate and/or execute the second fine-tuned deep learning model when the target task is to be performed. The processor of the system may be able to select, initiate and/or execute one or more fine-tuned models depending on the task being performed, so as to alternate between fine-tuned deep learning models based on the task. Alternatively, the processor may select and execute a deep learning model for a set period of time.

The comparison by one or more processors of system 100 can take into account the allocation of computing resources and the efficiency with which those resources are used within the system 100 when it is configured to perform the target task(s). Therefore, the selection and execution of a particular deep learning model based on the comparison can lead to system performance improvements such as processing speed gains, more efficient use of storage and more efficient use of system resources when conducting the task(s). By analyzing the performance of the first and second fine-tuned deep learning models, the one or more processors can determine, for example, which model will be more efficient at performing a specific task (e.g. which model provides optimal use of computing resources when performing the specific task), or which model, when principally performing a target task, will have a minimal performance degradation when performing other general tasks. The system can then select the optimal deep learning model based on the computing resources available or the expected utilization of those resources. The system 100 may take into account computing resource considerations relating to hardware.

As shown in FIG. 2B, at step 268, process 250 may include executing, by one or more processors, a deep learning model based on the comparison. For example, a processor of the testing system 104 and/or user device 108 may execute, based on the comparison, one of the first fine-tuned deep learning model and the second fine-tuned deep learning model. Additionally or alternatively, the processor(s) may execute the pre-trained deep learning model based on the comparison.

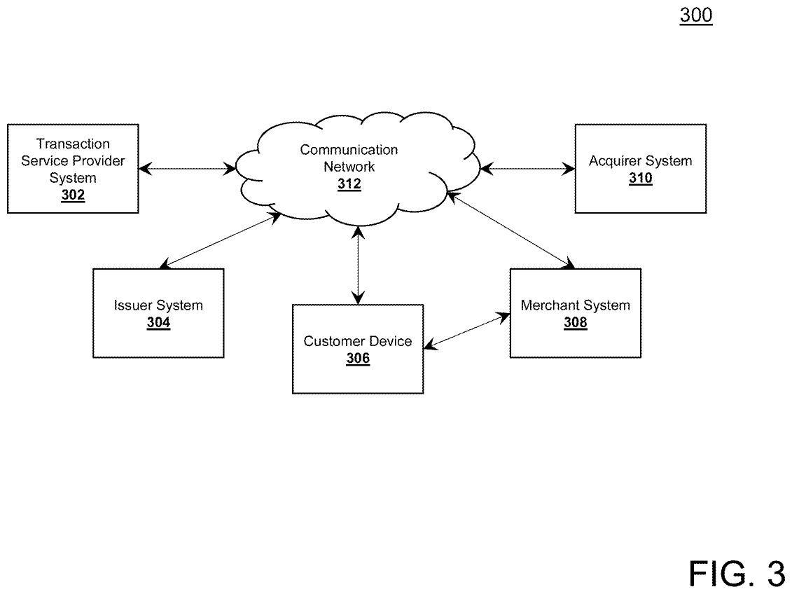

Referring now to FIG. 3, FIG. 3 is a diagram of an exemplary environment 300 in which systems, products, and/or methods, as described herein, may be implemented, according to some non-limiting embodiments or aspects of the presently disclosed subject matter. As shown in FIG. 3, environment 300 includes transaction service provider system 302, issuer system 304, customer device 306, merchant system 308, acquirer system 310, and communication network 312. In some non-limiting embodiments or aspects, each of training/fine-tuning system 102, testing system 104, model database 106, and/or user device 108 may be implemented by (e.g., part of) transaction service provider system 302. In some non-limiting embodiments or aspects, at least one of training/fine-tuning system 102, testing system 104, model database 106, and/or user device 108 may be implemented by (e.g., part of) another system, another device, another group of systems, or another group of devices, separate from or including transaction service provider system 302, such as issuer system 304, merchant system 308, acquirer system 310, and/or the like.

Transaction service provider system 302 may include one or more devices capable of receiving information from and/or communicating information to issuer system 304, customer device 306, merchant system 308, and/or acquirer system 310 via communication network 312. For example, transaction service provider system 302 may include a computing device, such as a server (e.g., a transaction processing server), a group of servers, and/or other like devices. In some non-limiting embodiments or aspects, transaction service provider system 302 may be associated with a transaction service provider, as described herein. In some non-limiting embodiments or aspects, transaction service provider system 302 may be in communication with a data storage device, which may be local or remote to transaction service provider system 302. In some non-limiting embodiments or aspects, transaction service provider system 302 may be capable of receiving information from, storing information in, communicating information to, or searching information stored in the data storage device.

Issuer system 304 may include one or more devices capable of receiving information and/or communicating information to transaction service provider system 302, customer device 306, merchant system 308, and/or acquirer system 310 via communication network 312. For example, issuer system 304 may include a computing device, such as a server, a group of servers, and/or other like devices. In some non-limiting embodiments or aspects, issuer system 304 may be associated with an issuer institution, as described herein. For example, issuer system 304 may be associated with an issuer institution that issued a credit account, debit account, credit card, debit card, and/or the like to a user associated with customer device 306.

Customer device 306 may include one or more devices capable of receiving information from and/or communicating information to transaction service provider system 302, issuer system 304, merchant system 308, and/or acquirer system 310 via communication network 312. Additionally or alternatively, each customer device 306 may include a device capable of receiving information from and/or communicating information to other customer devices 306 via communication network 312, another network (e.g., an ad hoc network, a local network, a private network, a virtual private network, and/or the like), and/or any other suitable communication technique. For example, customer device 306 may include a client device and/or the like. In some non-limiting embodiments or aspects, customer device 306 may or may not be capable of receiving information (e.g., from merchant system 308 or from another customer device 306) via a short-range wireless communication connection (e.g., an NFC communication connection, an RFID communication connection, a Bluetooth® communication connection, a Zigbee® communication connection, and/or the like), and/or communicating information (e.g., to merchant system 308) via a short-range wireless communication connection.

Merchant system 308 may include one or more devices capable of receiving information from and/or communicating information to transaction service provider system 302, issuer system 304, customer device 306, and/or acquirer system 310 via communication network 312. Merchant system 308 may also include a device capable of receiving information from customer device 306 via communication network 312, a communication connection (e.g., an NFC communication connection, an RFID communication connection, a Bluetooth® communication connection, a Zigbee® communication connection, and/or the like) with customer device 306, and/or the like, and/or communicating information to customer device 306 via communication network 312, the communication connection, and/or the like. In some non-limiting embodiments or aspects, merchant system 308 may include a computing device, such as a server, a group of servers, a client device, a group of client devices, and/or other like devices. In some non-limiting embodiments or aspects, merchant system 308 may be associated with a merchant, as described herein. In some non-limiting embodiments or aspects, merchant system 308 may include one or more client devices. For example, merchant system 308 may include a client device that allows a merchant to communicate information to transaction service provider system 302. In some non-limiting embodiments or aspects, merchant system 308 may include one or more devices, such as computers, computer systems, and/or peripheral devices capable of being used by a merchant to conduct a transaction with a user. For example, merchant system 308 may include a point-of-sale device and/or a point-of-sale system.

Acquirer system 310 may include one or more devices capable of receiving information from and/or communicating information to transaction service provider system 302, issuer system 304, customer device 306, and/or merchant system 308 via communication network 312. For example, acquirer system 310 may include a computing device, a server, a group of servers, and/or the like. In some non-limiting embodiments or aspects, acquirer system 310 may be associated with an acquirer, as described herein.

Communication network 312 may include one or more wired and/or wireless networks. For example, communication network 312 may include a cellular network (e.g., a long-term evolution (LTE) network, a third generation (3G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with a transaction service provider), an ad hoc network, an intranet, the Internet, a fiber optic-based network, a cloud computing network, and/or the like, and/or a combination of these or other types of networks.

In some non-limiting embodiments or aspects, processing a transaction may include generating and/or communicating at least one transaction message (e.g., authorization request, authorization response, any combination thereof, and/or the like). For example, a client device (e.g., customer device 306, a point-of-sale device of merchant system 308, and/or the like) may initiate the transaction, e.g., by generating an authorization request. Additionally or alternatively, the client device (e.g., customer device 306, at least one device of merchant system 308, and/or the like) may communicate the authorization request. For example, customer device 306 may communicate the authorization request to merchant system 308 and/or a payment gateway (e.g., a payment gateway of transaction service provider system 302, a third-party payment gateway separate from transaction service provider system 302, and/or the like). Additionally or alternatively, merchant system 308 (e.g., a point-of-sale device thereof) may communicate the authorization request to acquirer system 310 and/or a payment gateway. In some non-limiting embodiments or aspects, acquirer system 310 and/or a payment gateway may communicate the authorization request to transaction service provider system 302 and/or issuer system 304. Additionally or alternatively, transaction service provider system 302 may communicate the authorization request to issuer system 304. In some non-limiting embodiments or aspects, issuer system 304 may determine an authorization decision (e.g., authorize, decline, and/or the like) based on the authorization request. For example, the authorization request may cause issuer system 304 to determine the authorization decision based thereof. In some non-limiting embodiments or aspects, issuer system 304 may generate an authorization response based on the authorization decision. Additionally or alternatively, issuer system 304 may communicate the authorization response. For example, issuer system 304 may communicate the authorization response to transaction service provider system 302 and/or a payment gateway. Additionally or alternatively, transaction service provider system 302 and/or a payment gateway may communicate the authorization response to acquirer system 310, merchant system 308, and/or customer device 306. Additionally or alternatively, acquirer system 310 may communicate the authorization response to merchant system 308 and/or a payment gateway. Additionally or alternatively, a payment gateway may communicate the authorization response to merchant system 308 and/or customer device 306. Additionally or alternatively, merchant system 308 may communicate the authorization response to customer device 306. In some non-limiting embodiments or aspects, merchant system 308 may receive (e.g., from acquirer system 310 and/or a payment gateway) the authorization response. Additionally or alternatively, merchant system 308 may complete the transaction based on the authorization response (e.g., provide, ship, and/or deliver goods and/or services associated with the transaction; fulfill an order associated with the transaction; any combination thereof; and/or the like).

For the purpose of illustration, processing a transaction may include generating a transaction message (e.g., authorization request and/or the like) based on an account identifier of a customer (e.g., associated with customer device 306 and/or the like) and/or transaction data associated with the transaction. For example, merchant system 308 (e.g., a client device of merchant system 308, a point-of-sale device of merchant system 308, and/or the like) may initiate the transaction, e.g., by generating an authorization request (e.g., in response to receiving the account identifier from a portable financial device of the customer and/or the like). Additionally or alternatively, merchant system 308 may communicate the authorization request to acquirer system 310. Additionally or alternatively, acquirer system 310 may communicate the authorization request to transaction service provider system 302. Additionally or alternatively, transaction service provider system 302 may communicate the authorization request to issuer system 304. Issuer system 304 may determine an authorization decision (e.g., authorize, decline, and/or the like) based on the authorization request, and/or issuer system 304 may generate an authorization response based on the authorization decision and/or the authorization request. Additionally or alternatively, issuer system 304 may communicate the authorization response to transaction service provider system 302. Additionally or alternatively, transaction service provider system 302 may communicate the authorization response to acquirer system 310, which may communicate the authorization response to merchant system 308.

For the purpose of illustration, clearing and/or settlement of a transaction may include generating a message (e.g., clearing message, settlement message, and/or the like) based on an account identifier of a customer (e.g., associated with customer device 306 and/or the like) and/or transaction data associated with the transaction. For example, merchant system 308 may generate at least one clearing message (e.g., a plurality of clearing messages, a batch of clearing messages, and/or the like). Additionally or alternatively, merchant system 308 may communicate the clearing message(s) to acquirer system 310. Additionally or alternatively, acquirer system 310 may communicate the clearing message(s) to transaction service provider system 302. Additionally or alternatively, transaction service provider system 302 may communicate the clearing message(s) to issuer system 304. Additionally or alternatively, issuer system 304 may generate at least one settlement message based on the clearing message(s).

Additionally or alternatively, issuer system 304 may communicate the settlement message(s) and/or funds to transaction service provider system 302 (and/or a settlement bank system associated with transaction service provider system 302). Additionally or alternatively, transaction service provider system 302 (and/or the settlement bank system) may communicate the settlement message(s) and/or funds to acquirer system 310, which may communicate the settlement message(s) and/or funds to merchant system 308 (and/or an account associated with merchant system 308).

The number and arrangement of systems, devices, and/or networks shown in FIG. 3 are provided as an example. There may be additional systems, devices, and/or networks; fewer systems, devices, and/or networks; different systems, devices, and/or networks; and/or differently arranged systems, devices, and/or networks than those shown in FIG. 3. Furthermore, two or more systems or devices shown in FIG. 3 may be implemented within a single system or device, or a single system or device shown in FIG. 3 may be implemented as multiple, distributed systems or devices. Additionally or alternatively, a set of systems (e.g., one or more systems) or a set of devices (e.g., one or more devices) of environment 300 may perform one or more functions described as being performed by another set of systems or another set of devices of environment 300.

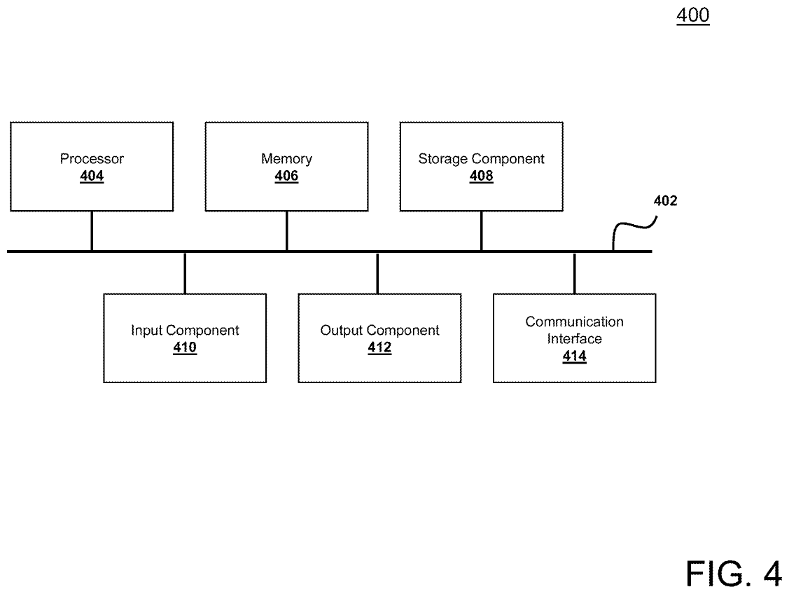

Referring now to FIG. 4, FIG. 4 is a diagram of exemplary components of a device 400, according to some non-limiting embodiments or aspects of the presently disclosed subject matter. Device 400 may correspond to one or more devices of the systems and/or devices shown in FIG. 1 or FIG. 3. In some non-limiting embodiments or aspects, each system and/or device shown in FIG. 1 or FIG. 3 may include at least one device 400 and/or at least one component of device 400. As shown in FIG. 4, device 400 may include bus 402, processor 404, memory 406, storage component 408, input component 410, output component 412, and communication interface 414.

Bus 402 may include a component that permits communication among the components of device 400. In some non-limiting embodiments or aspects, processor 404 may be implemented in hardware, firmware, or a combination of hardware and software. For example, processor 404 may include a processor (e.g., a central processing unit (CPU), a graphics processing unit (GPU), an accelerated processing unit (APU), and/or the like), a microprocessor, a digital signal processor (DSP), and/or any processing component (e.g., a field-programmable gate array (FPGA), an application-specific integrated circuit (ASIC), and/or the like), and/or the like, which can be programmed to perform a function. Memory 406 may include random access memory (RAM), read-only memory (ROM), and/or another type of dynamic or static storage device (e.g., flash memory, magnetic memory, optical memory, and/or the like) that stores information and/or instructions for use by processor 404.

Storage component 408 may store information and/or software related to the operation and use of device 400. For example, storage component 408 may include a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, and/or another type of computer-readable medium, along with a corresponding drive.

Input component 410 may include a component that permits device 400 to receive information, such as via user input (e.g., a touch screen display, a keyboard, a keypad, a mouse, a button, a switch, a microphone, a camera, and/or the like). Additionally or alternatively, input component 410 may include a sensor for sensing information (e.g., a global positioning system (GPS) component, an accelerometer, a gyroscope, an actuator, and/or the like). Output component 412 may include a component that provides output information from device 400 (e.g., a display, a speaker, one or more light-emitting diodes (LEDs), and/or the like).

Communication interface 414 may include a transceiver-like component (e.g., a transceiver, a receiver and transmitter that are separate, and/or the like) that enables device 400 to communicate with other devices, such as via a wired connection, a wireless connection, or a combination of wired and wireless connections. Communication interface 414 may permit device 400 to receive information from another device and/or provide information to another device. For example, communication interface 414 may include an Ethernet interface, an optical interface, a coaxial interface, an infrared interface, a radio frequency (RF) interface, a universal serial bus (USB) interface, a Wi-Fi® interface, a Bluetooth® interface, a Zigbee® interface, a cellular network interface, and/or the like.

Device 400 may perform one or more processes described herein. Device 400 may perform these processes based on processor 404 executing software instructions stored by a computer-readable medium, such as memory 406 and/or storage component 408. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 406 and/or storage component 408 from another computer-readable medium or from another device via communication interface 414. When executed, software instructions stored in memory 406 and/or storage component 408 may cause processor 404 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

The number and arrangement of components shown in FIG. 4 are provided as an example. In some non-limiting embodiments or aspects, device 400 may include additional components, fewer components, different components, or differently arranged components than those shown in FIG. 4. Additionally or alternatively, a set of components (e.g., one or more components) of device 400 may perform one or more functions described as being performed by another set of components of device 400.

Although the disclosed subject matter has been described in detail for the purpose of illustration based on what is currently considered to be the most practical and preferred embodiments or aspects, it is to be understood that such detail is solely for that purpose and that the disclosed subject matter is not limited to the disclosed embodiments or aspects, but, on the contrary, is intended to cover modifications and equivalent arrangements that are within the spirit and scope of the appended claims. For example, it is to be understood that the presently disclosed subject matter contemplates that, to the extent possible, one or more features of any embodiment or aspect can be combined with one or more features of any other embodiment or aspect.

1. A computer-implemented method, comprising:
receiving, with at least one processor, a deep learning model comprising a set of parameters and a dataset comprising a plurality of samples;
generating, with at least one processor, a respective noise vector for a respective sample of the plurality of samples, the respective noise vector generated based on a length of the respective sample and a radius hyperparameter;
repeating, with at least one processor, for a target number of steps:
adjusting, with at least one processor, the respective noise vector based on a step size hyperparameter; and
projecting, with at least one processor, the respective noise vector to be within a boundary based on the radius hyperparameter if the respective noise vector was adjusted beyond the boundary after adjusting the respective noise vector;
adjusting, with at least one processor, the set of parameters of the deep learning model based on a gradient of a loss based on the respective noise vector; and
repeating, with at least one processor, the generating, the repeating for the target number of steps, and the adjusting of the set of parameters for each sample of the plurality of samples.

2. The method of claim 1, wherein the deep learning model comprises a natural language processing (NLP) model.

3. The method of claim 2, wherein the NLP model comprises a Bidirectional Encoder Representations from Transformers (BERT) model.

4. The method of claim 1, wherein generating the respective noise vector comprises generating the respective noise vector based on the following equation:
$$δ = \frac{1}{\sqrt{{L}_{i}}} U ( - ϵ , ϵ )$$
wherein δ comprises the noise vector, Lᵢ comprises the length of the respective sample, ϵ comprises the radius hyperparameter, and U(−ϵ, ϵ) comprises a uniform distribution from −ϵ to ϵ.

5. The method of claim 1, wherein adjusting the respective noise vector comprises adjusting the respective noise vector based on the following equation:
$$δ = δ + α \cdot \frac{{∇}_{δ} ℓ ( {f}_{θ} ( {x}_{i} + δ ) , {y}_{i} )}{‖ {∇}_{δ} ℓ ( {f}_{θ} ( {x}_{i} + δ ) , {y}_{i} ) ‖}$$
wherein δ comprises the noise vector, α comprises the step size hyperparameter, [symbol] ( ) comprises a loss function, ƒ_{θ}( ) comprises an output of the deep learning model, ∇_{δ} is the gradient of δ, and yᵢ comprises an expected output of the deep learning model.

6. The method of claim 1, wherein projecting the respective noise vector comprises projecting the respective noise vector based on the following equation:
$$δ = \frac{δ}{max ( 1 , \frac{‖ δ ‖}{ϵ} )}$$
wherein δ comprises the noise vector and ϵ comprises the radius hyperparameter.

7. The method of claim 1, wherein adjusting the set of parameters comprises adjusting the set of parameters based on the following equation:
$$θ = θ - {∇}_{θ} ℓ ( {f}_{θ} ( {x}_{i} + δ ) , {y}_{i} )$$
wherein δ comprises the noise vector, ϵ comprises the set of parameters, l( ) comprises a loss function, ƒ_{θ}( ) comprises an output of the deep learning model, and yᵢ comprises an expected output of the deep learning model.

8. The method of claim 1, further comprising:
repeating, with at least one processor, for a target number of epochs, the repetition of the generating, the repeating for the target number of steps, and the adjusting of the set of parameters for each sample of the plurality of samples.

9.-17. (canceled)

18. A system, comprising:
at least one processor configured to:
receive a deep learning model comprising a set of parameters and a dataset comprising a plurality of samples;
generate a respective noise vector for a respective sample of the plurality of samples, the respective noise vector generated based on a length of the respective sample and a radius hyperparameter;
repeat for a target number of steps:
adjust the respective noise vector based on a step size hyperparameter; and
project the respective noise vector to be within a boundary based on the radius hyperparameter if the respective noise vector was adjusted beyond the boundary after adjusting the respective noise vector;
adjust the set of parameters of the deep learning model based on a gradient of a loss based on the respective noise vector; and
repeat the generating, the repeating for the target number of steps, and the adjusting of the set of parameters for each sample of the plurality of samples.

19. A computer program product comprising at least one non-transitory computer-readable medium including one or more instructions that, when executed by at least one processor, cause the at least one processor to:
receive a deep learning model comprising a set of parameters and a dataset comprising a plurality of samples;
generate a respective noise vector for a respective sample of the plurality of samples, the respective noise vector generated based on a length of the respective sample and a radius hyperparameter;
repeat for a target number of steps:
adjust the respective noise vector based on a step size hyperparameter; and
project the respective noise vector to be within a boundary based on the radius hyperparameter if the respective noise vector was adjusted beyond the boundary after adjusting the respective noise vector;
adjust the set of parameters of the deep learning model based on a gradient of a loss based on the respective noise vector; and
repeat the generating, the repeating for the target number of steps, and the adjusting of the set of parameters for each sample of the plurality of samples.

20.-21. (canceled)

22. The system of claim 18, wherein the deep learning model comprises a natural language processing (NLP) model.

23. The system of claim 22, wherein the NLP model comprises a Bidirectional Encoder Representations from Transformers (BERT) model.

24. The system of claim 18, wherein generating the respective noise vector comprises generating the respective noise vector based on the following equation:
$$δ = \frac{1}{\sqrt{{L}_{i}}} U ( - ϵ , ϵ )$$
wherein δ comprises the noise vector, Lᵢ comprises the length of the respective sample, ϵ comprises the radius hyperparameter, and U(−ϵ, ϵ) comprises a uniform distribution from −ϵ to ϵ.

25. The system of claim 18, wherein adjusting the respective noise vector comprises adjusting respective noise vector based on the following equation:
$$δ = δ + α \cdot \frac{{∇}_{δ} ℓ ( {f}_{θ} ( {x}_{i} + δ ) , {y}_{i} )}{‖ {∇}_{δ} ℓ ( {f}_{θ} ( {x}_{i} + δ ) , {y}_{i} ) ‖}$$
wherein δ comprises the noise vector, α comprises the step size hyperparameter, [symbol] ( ) comprises a loss function, ƒ_{θ}( ) comprises an output of the deep learning model, ∇_{δ} is the gradient of δ, and yᵢ comprises an expected output of the deep learning model.

26. The system of claim 18, wherein projecting the respective noise vector comprises projecting the respective no vector based the following equation:
$$δ = \frac{δ}{max ( 1 , \frac{‖ δ ‖}{ϵ} )}$$
wherein δ comprises the noise vector and ϵ comprises the hyperparameter.

27. The system of claim 18, wherein adjusting the set of parameters comprises adjusting the set of parameters be ad on the following equation:
$$θ = θ - {∇}_{θ} ℓ ( {f}_{θ} ( {x}_{i} + δ ) , {y}_{i} )$$
wherein δ comprises the noise vector, θ comprises the set of parameters, l( ) comprises a loss function, ƒ_{θ}( ) comprises an output of the deep learning model, and yᵢ comprises an expected output of the deep learning model.

28. The system of claim 18, wherein the at least one processor is further configured to:
repeat, for a target number epochs, the repetition of the generating, the repeating for the target number of steps, and the adjusting of the set of parameters for each sample of the plurality samples.

29. The computer program product of claim 19, wherein the deep learning model comprises a natural language processing (NLP) model, and
wherein the NLP model comprises Bidirectional Encoder Representations from Transformers (BERT) model.

30. The computer program product of claim 19, wherein generating the respective noise vector comprises generating the respective noise vector based on the following equation:
$$δ = \frac{1}{\sqrt{{L}_{i}}} U ( - ϵ , ϵ )$$
wherein δ comprises the noise vector, Lₗ comprises the length of the respective sample, ϵ comprises the radius hyperparameter, and U(−ϵ,ϵ) comprises a uniform distribution from −ϵ to ϵ,
wherein adjusting the respective noise vector comprises adjusting the respective noise vector based on the following equation:
$$δ = δ + α \cdot \frac{{∇}_{δ} ℓ ( {f}_{θ} ( {x}_{i} + δ ) , {y}_{i} )}{‖ {∇}_{δ} ℓ ( {f}_{θ} ( {x}_{i} + δ ) , {y}_{i} ) ‖}$$
wherein δ comprises the noise vector, α comprises the step size hyperparameter, [symbol] ( ) comprises a loss function, ƒ_{θ}( ) comprises an output of the deep learning model, ∇_{δ} is the gradient of δ, and yᵢ comprises an expected output of the deep learning model,
wherein projecting the respective noise vector comprises projecting the respective noise vector based on the following equation:
$$δ = \frac{δ}{max ( 1 , \frac{‖ δ ‖}{ϵ} )}$$
wherein δ comprises the noise vector and ϵ comprises the radius hyperparameter, and
wherein adjusting the set of parameters comprises adjusting the set of parameters based on the following equation:
$$θ = θ - {∇}_{θ} ℓ ( {f}_{θ} ( {x}_{i} + δ ) , {y}_{i} )$$
wherein δ comprises the noise vector, θ comprises the set of parameters, [symbol] ( ) comprises a loss function, ƒ_{θ}( ) comprises an output of the deep learning model, and yᵢ comprises in expected output of the deep learning model.

31. The computer program on product of claim 19, wherein the one or more instructions, when executed by the at least one processor, further cause the at least one processor to:
repeat, for a target number of epochs, the repetition of the generating, the repeating for the target number of steps, and the adjusting of the set of parameters for each sample of the plurality of samples.
